(19) United States
(12) Patent Application Publication
(10) Pub. No.: US 2025/0326474 A1
(43) Pub. Date: Oct. 23, 2025

(54) SWIMMER EMERGENCY ALERTING, TRACKING, RESCUE ASSISTANCE, AND RIP CURRENT MAPPING SYSTEM

(71) Applicant: BSS TECHNOLOGIES, INC., Takoma Park, MD (US)

(72) Inventors: Sunil Kumar RAJENDRAN, Cary, NC (US); William C. Sandberg, Takoma Park, MD (US)

(21) Appl. No.: 19/186,256

(22) Filed: Apr. 22, 2025

Related U.S. Application Data
(60) Provisional application No. 63/637,641, filed on Apr. 23, 2024.

(51) Int. Cl. B63C 9/20; B63C 9/00; B63C 9/08; B63C 9/22; G05D 1/646; G05D 101/15; G05D 105/55; G05D 107/00; G05D 109/20; G05D 109/30; G05D 111/10; G06K 19/07; G06V 10/82; G06V 20/17

(52) U.S. Cl. CPC B63C 9/20; B63C 9/082; B63C 9/22; G05D 1/646; G06K 19/0723; G06V 10/82; G06V 20/17; B63C 2009/0017; G05D 2101/15; G05D 2105/55; G05D 2107/27; G05D 2109/20; G05D 2109/34; G05D 2111/10

(57) ABSTRACT

A swimmer emergency alerting, tracking, rescue assistance, and rip current mapping system includes a stand and a life preserver that is removably mounted to the stand. The stand includes a solar panel or other charger, and the life preserver includes a battery receiving power from the charger and a sensor that is driven by the battery, such as to detect a location of the life preserver. The stand and the life preservers may wirelessly communicate with another device, such as a user device, to provide information on a status of the stand and the life preserver. A drone may fly from the stand and collect images of a shore, and the drone may process the images to identify a rip current. The drone may use data from a watercraft identifying rip current to train the processing of the images.

### CROSS-REFERENCE TO RELATED PATENT APPLICATION(S)

This application claims priority under 35 U.S.C. § 119(e) to U.S. Provisional Patent Application No. 63/637,641, filed Apr. 23, 2024, whose content is hereby incorporated by reference in its entirety.

### BACKGROUND

A life preserver, also referred to as a life ring, a life buoy, a ring buoy, life-saving buoy, or buoyancy support ring, is a floatation device that may be provided to a swimmer in the water to provide buoyancy to prevent drowning. For example, a life preserver may be positioned near water or on a watercraft vehicle when not in use and thrown toward or otherwise provided to a swimmer in distress. The life preserver may be provided as a ring having a substantially circular shape with an inner cavity to assist in throwing and grabbing the life ring, or to enable the distressed swimmer to wear the ring with their arms curled around the side to securely hold on the ring and their head protruding out of the inner cavity, but that life preserver may be also provided in various other configurations, such as in a bar shape or as a jacket. The life preserver may be coupled to a rope to allow the life preserver to be recovered after throwing and to assist in rescue of a swimmer holding onto the life preserver. At least a portion of an outer surface of the life preserver may be painted a color, such as yellow or orange, that is more easily visually detectable in water or to have a reflective property, and the life preserver may include a light that is activated in water to aid in rescues at night or in other dark conditions.

### BRIEF DESCRIPTION OF THE DRAWINGS

FIGS. 1A and 1B illustrate components of a beach safety system in accordance with certain embodiments;

FIG. 2A is a schematic illustration of a life ring included in the beach safety system in certain embodiments;

FIGS. 2B-2E are views of the life ring included in the beach safety system in certain embodiments;

FIG. 3A is a schematic illustration of a stand included in the beach safety system in certain embodiments;

FIGS. 3B and 3C are views of a stand included in the beach safety system in certain embodiments;

FIG. 4 is a schematic illustration of a user device included in the beach safety system in certain embodiments;

FIG. 5 is a flow chart illustrating a process to provide rescue information in the beach safety system of in certain embodiments;

FIGS. 6A and 6B illustrate components of a beach safety system in accordance with certain embodiments;

FIG. 7 is a schematic illustration of an unmanned aerial vehicle (UVA) included in the beach safety system in certain embodiments;

FIG. 8 is a schematic illustration of an unmanned surface vehicle (USV) included in the beach safety system in certain embodiments;

FIG. 9 is a map depicting movement paths of an UAV and an USV in certain embodiments of in the beach safety system;

FIG. 10 is a map depicting dangerous water conditions that is generated in certain embodiments of in the beach safety system; and

FIGS. 11A-11C depicts components of a caddy included in the beach safety system in certain embodiments.

### DETAILED DESCRIPTION OF PREFERRED EMBODIMENTS

As described below with respect to the drawings, aspects of the present application relate to a coherent beach safety system 100 with the capability to alert first responders, beach personnel, and beach visitors of distressed swimmers in need of immediate assistance and to provide beach visitors an alert warning of dangerous conditions to avoid and where to move on the beach in order not to be in the dangerous conditions. The system operation may include several actions:—1) real-time autonomous detection of dangerous beach conditions, 2) real-time tracking of distressed swimmers, 3) real-time autonomous UAV rescue response to the distressed swimmers, 4) issuance of real-time swimmer emergency alert notifications to first responders, and 5) real-time in situ automatic notification of beach dangers and guidance to safer areas for beach visitors and general public.

The coherent beach safety system may include various hardware and software components, such as a trackable life-ring, a life-ring mount and life ring motion detection system, an autonomous unmanned aerial vehicle (UAV) system, a self-sufficient solar energy harvesting system, a fail-safe communication system, a hardware status monitoring software dashboard, a hardware data accumulation software, an automated life-ring statistics analysis and report generation software, and a beach safety smartphone application implemented on a device, such as smart phone.

In certain implementations of the beach safety system, a trackable life ring included in the coherent beach safety system may be equipped with motion sensors to detect life ring removal from holders. Life ring removal may trigger alerts to first responders and authorized personnel, and the alerts are instantaneously issued in the form of SMS text messages, emails, phone calls with dynamic voice message, radio messages, smartphone push notifications, MQTT (Message Queuing Telemetry Transport) messages, HTTP webhooks. For example, the alert messages may identify a time of the event, a location of the emergency (in the form of GPS coordinates, name of the nearest beach access crossover/boardwalk/street intersection, and landmarks), and a URL link to a dashboard to monitor the live local beach location of the swimmer emergency. The live tracking of the life ring motion trajectory can be viewed on smartphone or computer monitor and is enabled via continuous transmissions of GPS coordinates. Additionally, the life ring may be equipped with wireless charging system so the unit never needs to be opened for charging purposes, and the life ring may have a low power mode capability of the life ring when idle on the stand, thus saving battery capacity and reducing energy consumption. Furthermore, the life ring is capable upon radio-controlled activation of releasing fluorescent dye when deployed in water for quick visual detection of distressed swimmers during air rescue and to highlight and visually show the time-varying dynamics of dangerous currents in the surf-zone to assist in video and image capture by the autonomous UAV for subsequent Al-enabled data analysis.

In certain implementations of the beach safety system, a life-ring mount and detection system may include a snap fitting mechanism for quick removal of life ring in the event of emergency (e.g., less than 1 second to remove). The life-ring mount may include a tri-holder with spring for easy placement of life ring during return to holders, and may have a robust design to accommodate sensing of life ring presence despite having inconsistencies in the physical dimensions of life rings due to manufacturing defects that includes adjustable tri-holders along the radial axes so the system can adapt to life rings of all sizes and to supply adjustable tension on the spring-loaded pole to accommodate release/return motion of differently sized life-rings. Furthermore, all three poles may include sensors to prevent tampering with the detection system. For example, the sensing methods may include waterproof tactical push buttons or snap action limit switches near the passive poles and magnetic reed switches or photoelectric sensors or load cell sensors near the active spring-loaded pole. The mount may also be equipped with sound alarms with flashing lights for situational awareness of beach public and deterrent to vandalism, while also providing a 360-degree rotation of the life ring around its center origin is possible without triggering the alarm to enable prevention of intentional false alarms and deter vandalism.

Certain aspects of the beach safety system include an autonomous UAV system having artificial intelligence AI software and cameras for swimmer detection, rip current identification, and marine creature detection. The UAV may be capable of autonomous launch, transit, charging, and docking, capable of autonomously identifying and pinpointing distressed swimmer based on gesture analysis of the beach visitors, and capable of providing life-saving rapid rescue of distressed swimmers by delivering floatation device to the identified location immediately. For example, the autonomous UAV system may be equipped with 4K high resolution cameras and capability to autonomously scan beaches and detect rip currents, and may be equipped with 4K high resolution cameras, thermal imaging infrared cameras, and machine learning software to detect possible dangerous marine wildlife such as jelly fish on the shore and predatory species in the near surf-zone. Additionally, the autonomous UAV system may be capable of providing property surveillance along the beach and the adjacent land areas, and may be further capable of transmitting GPS coordinates of the location of the distressed swimmer, dangerous marine wildlife, and dangerous surf-zone currents in real-time.

Another aspect of the beach safety system may include a self-sufficient solar energy harvesting system that enables solar panel charging of one or more of the stand system, life ring, and UAV system. Additionally, aspects of the beach safety system include a backup battery to provide charge in case of prolonged days with less or no sunlight.

Another aspect of the beach safety system may include a fail-safe communication system. For example, the beach safety system may include a communication system equipped with long range (LoRa) technology, radio technology, narrowband internet of things (NB-IoT), or long-term evolution (LTE) cellular technology, and satellite communication technology to provide fail-safe communication of emergency events. For example, the communication system is installed in life ring, the stand, and the UAV, and as the UAV, stand, and life ring may include WiFi and Bluetooth® communication modules for near-range high data download and programming of the devices.

Another aspect of the beach safety system may include a data and device monitoring software dashboard. The data and device monitoring software dashboard may allow access to life ring-specific information, such as elapsed time duration since release of life ring, battery status, estimated time left to depletion of battery since release of life ring, real-time location tracking of life ring, real-time motion tracking of the life ring, signal strength of the communication system, charging status. Furthermore, the data and device monitoring software dashboard may allow access to life ring support stand-specific information: battery status, charging status, and communication system health. Additionally, the data and device monitoring software dashboard may allow access to UAV-specific information such as battery status, camera(s) status, real-time trajectory tracking of the UAV, 4K live video feed and last snapshot captured, launch/transit/dock and charging status.

Another aspect of the beach safety system may include hardware data accumulation software. For instance, the beach safety system may include a system-specific hardware data recorder for future analysis and software integrated on the dashboard to log data remotely in real-time. Data types to be recorded may include motion, timestamps, video, snapshots, global positioning system (GPS) coordinates or other location data of the UAV and life ring, and local environmental data.

Another aspect of the beach safety system may include an automated statistics report generation system. This automated statistics report generation system may automatically generate periodic statistics reports. These reports may include information on locations of support stands, a number of life ring removal events from each stand, reason for removal, alert durations, response durations, and emergency personnel response times, etc. Furthermore, the reports may also include technical information of each system such as battery charge and discharge graphs to analyze battery health, charging durations, solar power, etc.

Another aspect of the beach safety system may include a beach safety smartphone application. The beach safety smartphone application may be capable of automatically sending alerts to users when the user enters a zone with dangerous beach conditions (e.g., rip currents, marine wildlife, etc.). Furthermore, the beach safety smartphone application may be capable of providing guidance to the user to exit the danger zone and where to move to be in a safer zone for swimming.

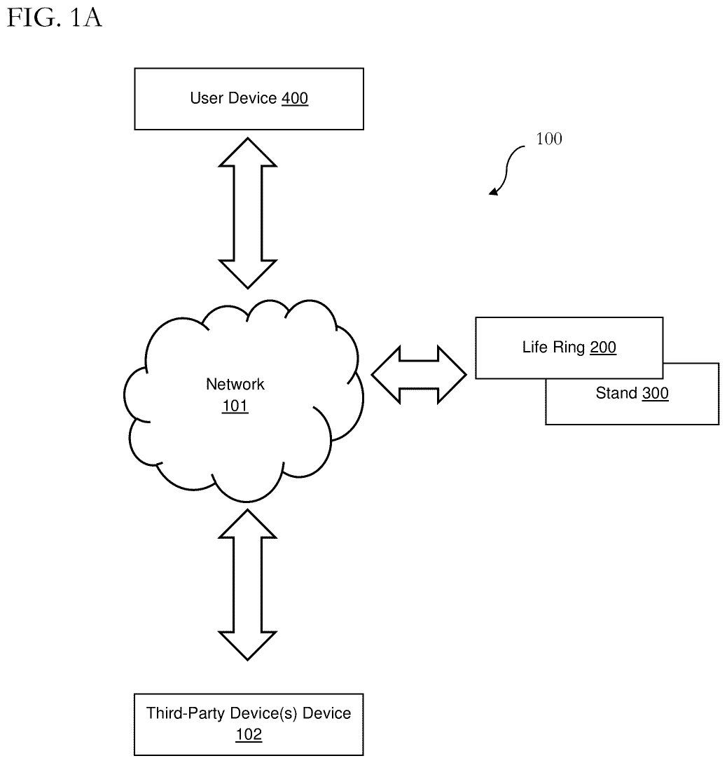

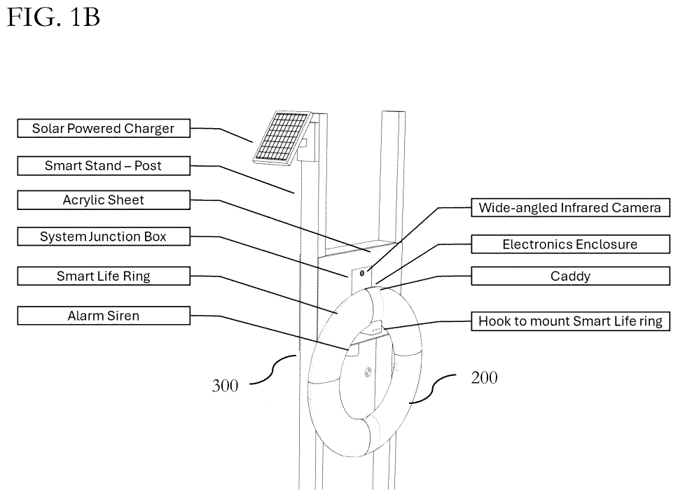

Referring to FIGS. 1A, 1B, 2A-2E, 3 and 4, aspects of the present application relate to a beach safety system 100 including a life ring (or floatation device) 200, a stand 300 that is a support structure to which the life ring 200 may be coupled and stored when not in use, and a user device 400 that communicates with the life ring 200 and the stand 300, such as to provide instructions to the life ring 200 or the stand 300, to receive data collected by the life ring 200 or the stand 300, to forward the data to another device (e.g., third party device 102), and to connect the other device (e.g., third party device 102) to the life ring 200 and/or stand 300. The user device 400 may wirelessly communicate with the life ring 200 or the stand 300 via a network 101, such as a radio access network or a wi-fi or internet-of-things network or via a radio signal, such as via Bluetooth® or Zigbee® signals. Furthermore, the user device 400 may communicate with a third-party device 102, such as a computing or communication device operated by a first responder. The user device 400 may correspond to a computing device or communication device, such as a smart phone. While the beach safety system 100 is discussed herein in the context of a single user device 400 communicating with a single life ring 200 associated with a single stand 300, it should be appreciated that beach safety system 100 may have different configurations, such as providing multiple life rings 200 on a single stand 300 or using the user device 400 with multiple different pairs of life rings 200 and stands 300.

In an example depicted in FIG. 1B, the stand (also referred to as a smart stand) 300 may include one more posts to support a system junction box and an electronics enclosure that includes an acrylic sheet to house various electronics in a water-resistant structure. The stand 300 may include a caddy having a hook or other connection device to receive the life ring (also referred to as a smart life ring) 200 for storage when not in use. Furthermore, stand 300 may include a power source such as a solar charger to provide power to the life ring 200, and a sensor such as a wide angled infrared camera to capture images and videos of a surroundings of the stand 300, such as to capture images to of a user removing the life ring 200 from the stand 300 or images of water and other environmental conditions near the stand 300. Thus, the life ring 200 and the stand 300 may be sustainable using solar energy with a backup battery for power in case of adverse circumstances, such as prolonged cloudy days or night operations.

As described in greater detail below, when life ring 200 is lifted from or otherwise removed from stand 300, such as to be thrown to a swimmer in distress, one or more components of the beach safety system 100 may provide an alert to first responders and/or to beach visitor that the swimmer needs immediate assistance. For example, the stand 300 may include an alarm, such as a siren or a pulsing light, that is activated when the life ring 200 is removed from the stand 300. In another example, lifting the life ring 200 off the stand 300 may trigger electronics installed in the beach safety system 100, such as to transmit electronic alerts, initiate tracking of the path of the life ring 200, and to transmit electronic signal regarding a tracked location of the life ring 200 to hasten a rescue response.

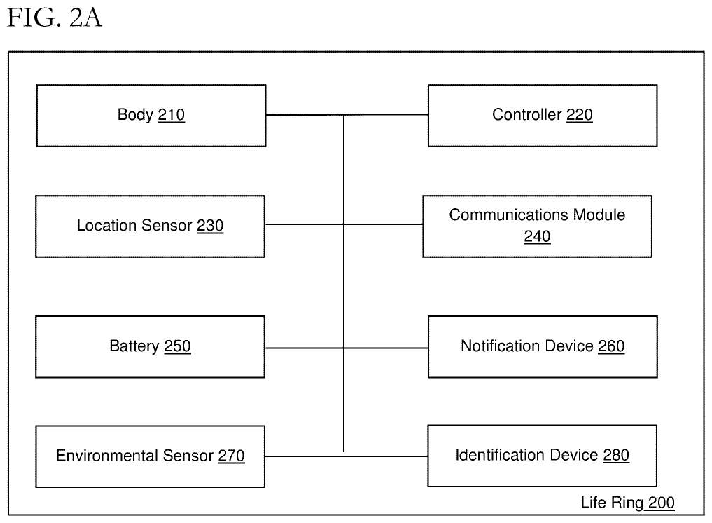

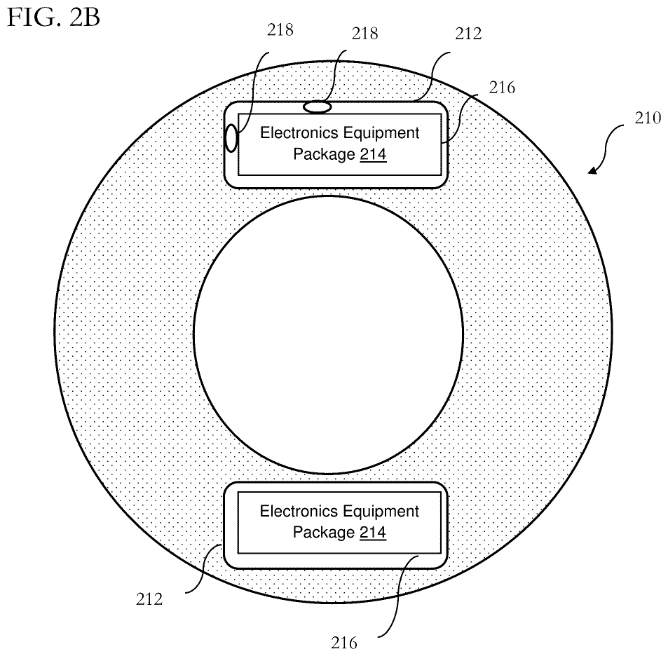

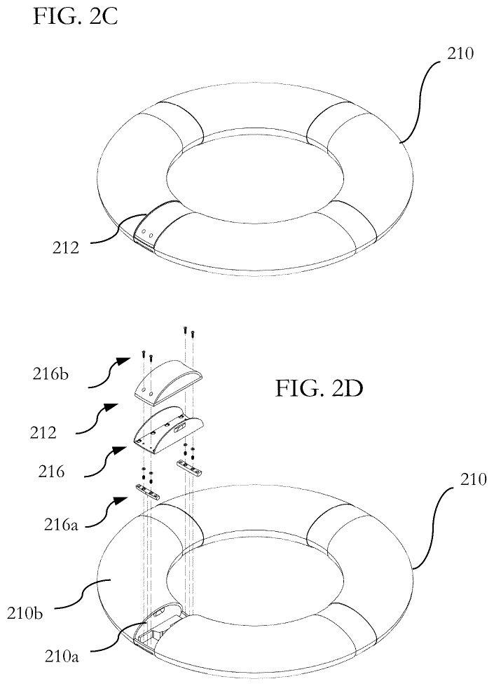

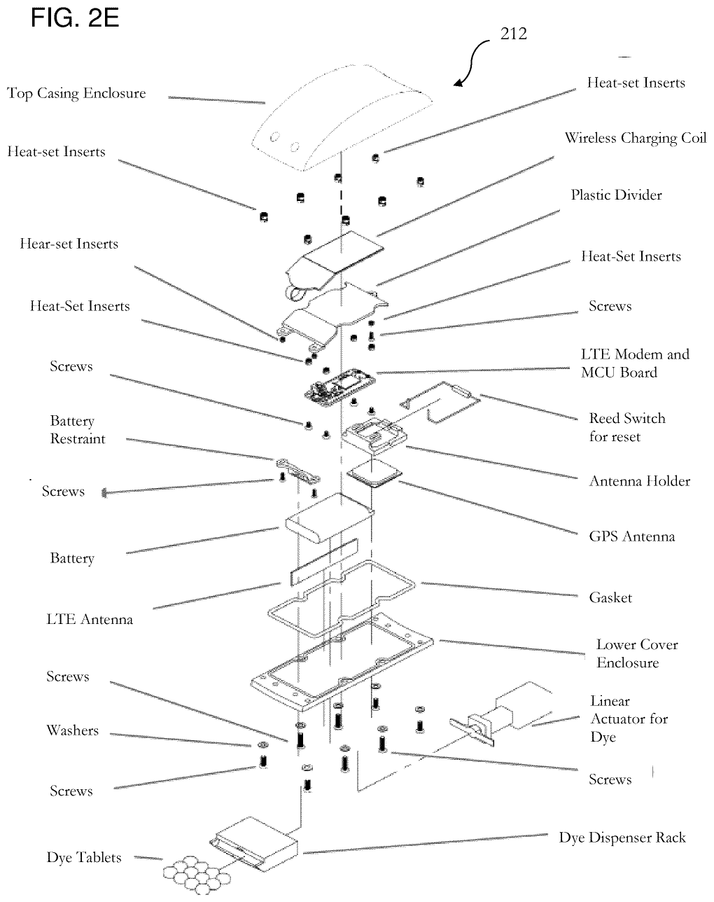

Referring to FIGS. 2A-2E, the life ring 200 may provide buoyancy for distressed swimmers and may also transmit its coordinates as the life ring 200 changes location in the moving water. In certain implementations, the life ring 200 may include components to perform various functions, such as to receive and store electromagnetic energy from stand 300, to determine to a motion and orientation of the life ring 200, to acquire coordinates of the life ring 200, to provide a unique identification for the life ring 200, and to communicate a release of the life ring 200 from the stand 300. For example, in certain implementations, the life ring 200 may include a body (or ring body) 210, a controller (or ring controller) 220, a location sensor (or ring location sensor) 230, a communication module (or ring communication module) 240, a battery (or ring battery) 250, a notification device (or ring output device) 260, an environmental sensor (or ring environmental sensor) 270, and an identification device (or ring identification device) 280. It should be appreciated that the life ring 200 may include fewer or additional components.

The body 210 may include a life ring shell 210a that forms a skeleton or structural support frame for the life ring 200 and may be formed of a low density polyethylene plastic or other rigid material. The body 210 may further include a buoyant material coupled 210b to the life ring shell 210a, such as cork or a foamed plastic to trap air bubbles and a sturdy outer housing that prevents damage to the buoyant material. The body 210 may be formed in various shapes, such as in a substantially circular shape to allow the life ring 210 to be thrown by a user toward a swimmer and to allow the swimmer to grab onto the life ring 210.

Referring to FIGS. 2B-2E, the body 210 may define an enclosure 212 to receive an electronics system package 214 including electronic components of the life ring 200 (e.g., one or more of the controller 220, the location sensor 230, the communication module 240, the battery 250, the notification device 260, the environmental sensor 270, and the identification device 280). For example, the electronics system package may be inserted into the enclosure 212 that is received in an opening that is cut or carved from the body 210 to define a slot to precisely sized to fit a custom-designed plastic caddy 216 onto which the electronics package may be secured and locked in place, such as by screws or bolts 216a and brackets 216b. The storage caddy may include motion restricting protuberances 218 to prevent motion of the electronics system package within the enclosure 212. The electronics system package may be sealed within the body 210 to provide a water-resistant space, such as to meet the expectation of an IP 68 waterproof rating or other water resistance standards, while seamlessly fitting withing the curved shape of the life ring 200 to hold the electronics securely in place. For example, the caddy and the electronics enclosure may be secured to the body 210 of the life ring 200 using heat-set threaded inserts, washers, and machine screws made of titanium material for prolonged corrosive resistance in marine environments.

In certain implementations, the body 210 may position the components of the electronics system package to accomplish specific performance goals. For example, the body 210 may position the electronic components to disperse the weight of the electronic components and to maintain the buoyancy of the life ring and to improve a throwing distance of the life ring, such as to position the relatively heavy battery 250 in a first radial direction, and position the other electronic components in a second, opposite radial direction so that a center of gravity of the life ring 200 substantially corresponds to a center of the life ring. In another example, the body 210 may space the electronic components at least a threshold distance (e.g., 10 mm or more) from an outer circumferential surface so that a portion of the body 210 can cushion an impact force and protect the electronic components when the life ring is dropped. In another example, the body 210 may position the electronic components relatively closer to the outer circumferential surface of the body 210 than to an inner circumferential surface associated with a central cavity to provide a relatively greater rotational inertia, which may help a user throw the life ring 200 farther and more accurately.

The controller (or CPU) 220 may process information received from the stand 300 or the control device 400 or information collected by the life ring 200. For example, the controller 220 may determine when the life ring is removed from the stand 300 and activate one or more components of the life ring 200, such as the location sensor 230 and the communications module 240. The controller 220 may determine a location of the life ring 200 based on the location sensor 230, and may interface with the communication module 240 to periodically or continuously transmit an indication of the location of the life ring 200. Furthermore, the controller 220 or other components of the beach safety system 100 may use the positions of the life ring 200 to compute the magnitude and direction of currents in the water so that first responders may better determine a real-time location of a swimmer holding onto the life ring 200 and to identify any dangerous currents or other conditions around the life ring 200. For example, the controller 220 may determine that the swimmer is in rip current or other dangerous flow when the life ring 200 is moving above a threshold speed from land and may issue a warning regarding the rip current to the user device 400. The life ring may be equipped with a motion sensor or IMU, which can assist in obtaining a more accurate flow magnitude and direction in addition to the data obtained from the location sensor.

The location sensor 230 may collect data used to identify a location of the life ring 200. For example, the location sensor 220 may include an antenna to detect a transmission from one or more components of a global position system (GPS) and may process the transmission to calculate a geographical position of the life ring 200. The environmental sensors 270 may further include one or more sensors to determine a movement of the rife ring. For example, the environmental sensors 270 may include an inertial measurement unit (IMU) to determine a rate of movement of the life ring 200 in the water. In other examples, the communications module 240 may determine a position of the life ring 200 based on relative strengths of communications signals received by the communications module 240 from the stand 300, user device 400 and/or from network 101, such as to determine distances from the life ring 200 to the stand 300 and/or components of the network 102 (e.g., a base station) and use these distances to triangulate a location of the life ring 200.

The communication module 240 may transmit data to the stand 300, user device 400 or to third party device 102. For example, the communications module may include an antenna that transmits signals to the stand 300, user device 400, or to third party device 102 through network 101 and a processor to encode data for a signal transmitted through the antenna.

In one implementation, the controller 220 and communications module 240 may be provided by an nRF9160 System-in-Package from Nodic Semiconductor® to establish communications to relay real-time data. For example, the nRF9160 module may talk to an inertial measurement unit (IMU) and a GPS module included in the location sensor 230 to obtain the linear acceleration of along a three-dimensional Cartesian axes, course, orientation, and GPS coordinates of the life ring 200. Then, a signal strength of the cellular and GPS modules included in the communications module 240 may be amplified using communications data (e.g., LTE) and GPS antennas which fit inside the waterproof enclosure inside the body 210 of the life ring. There are also nRF9151 and nRF9161 alternative new versions from Nordic. There are also nRF52 and nRF53 SoC series which offer Bluetooth, Bluetooth mesh, Zigbee, Thread, and ANT, and 802.15.4 communications.

Furthermore, the life ring 200 may incorporate a buck converter to power the main microcontroller unit 220 based on nRF9160 System-in-Package from Nordic Semiconductors which runs on 3.3 volts. The microcontroller unit 220 is the heart of all operations in the system junction box which is responsible for establishing cellular communications in the narrow band LTE channel and communicating with an Internet-of-Things (IoT) cloud server.

The battery 250 may store power to drive the other components of the life ring 200 within body 210. For example, the battery 250 may be a lithium-ion polymer (LiPo) battery or other type of rechargeable battery. The battery 250 may be charged when stored on the stand 300. For example, the battery 250 may use a wireless receiver charging coil within the enclosure 212 to wirelessly receive power from a wireless transmitter charging coil in the stand 300 which charges the battery 250, thus avoiding the necessity to open the enclosure 212 to charge the battery 250 or avoiding the necessity of an external wired charging port which is subjected to short-circuits and electronics malfunction caused due to exposure to salt water.

In operation, battery 250 may operate in at least two modes, such as a “Normal Mode” after the life ring 200 is removed from the stand 300 and in use, and a “Power Saving Mode” when the life ring 200 is idle, such as when the life ring 200 is mounted on the stand 300. In the normal mode when the life ring 200 is in use, the battery 250 may continuously power electronics in the life ring 200, such as to allow the location sensor 230 to determine a location of the life ring 200 and to allow the controller 220 to operate with communications module 240 to continuously transmit real-time sensor and location information of the life ring 200. In the power saving mode when the life ring 200 is mounted on the stand 300, the battery 250 may still power certain electronics of life ring 200 but the location sensor 230 and other components which consume relatively higher amounts of electrical current may be put into semi-sleep mode to consume very minimal current, while allowing the controller 220 to immediately start transmitting time-sensitive information when system is woken up and switched to the normal mode in response to being removed from the stand 300. In the power saving mode when the life ring 200 is mounted on the stand 300, the controller 220 may still periodically transmit messages to the user device 400 or third-party device 102 through the network 101 to remain established and indicate the constant connection to the connectivity services in the low powered mode which resembles heart-beat messages to notify the device's online status and reduce any connection establishment times in the event of swimmer emergencies.

The battery 250 may be charged while the life ring 200 is mounted on stand 300. For example, the battery 250 may be charged by wireless charging, such as through electromagnetic induction. The stand 300 (e.g., charger 330 to be discussed below) may include a charging station or pad through which an alternating current is provided to generate a magnetic field that fluctuates in strength due to the alternating current. The battery 250 may include or may be coupled to an inductive coil that is positioned within the magnetic field when the life ring 200 is mounted on stand 300, and the changing magnetic field creates an alternating electric current in the induction coil. The alternating electric current in the induction coil may then pass through a rectifier to form a direct current that is used to charge the battery 250.

In certain implementations, two or more reed switches or other switches may be coupled to battery 250, such as one on a bottom of the life ring 200 which acts as a release sensor switch, and another reed switch on a top of the life ring 200 that acts as a master reset switch for the electronics components. For example, the bottom reed switch may switch on when the life ring 200 is removed from stand 300 to send a trigger signal to the controller 220 indicating that the life ring 200 is released from stand 300. The upper master reset reed switch enables a user to magnetically reset the electronics as a first solution in case of any software/firmware issues, without having to open the entire electronics to reset the system. For example, the master reset reed switch may allow a user to selectively cease a flow of power from the battery 250 and to the controller 220, such that controller 220 may be manually restarted.

Continuing with FIG. 2A, the life ring 200 may include the identification device (or ring identifier) 280. For example, the identification device 280 may include an RFID tag that is used by the stand 300 to identify the life ring 200. For example, the RFID tag in identification device 280 may be a small radio transponder that is triggered by an electromagnetic interrogation pulse from a RFID reader (e.g., life ring sensor 320 to be discussed below) in the stand 300 to transmit digital data, such as an inventory number, and the stand 300 uses this digital data from the RFID tag to identify the life ring 200. In another example, the identification device 280 may be integrated into communications module 240, and the communications module 240 may include identifying data in transmissions to other devices, such as to the stand 300. However, if the switch enables power to the electronic components, then the entire electronic system will have to go through a cold start which could take up more time to establish connection to the network and send the alert message. In certain implementation, the portion of the life ring with the reed switch is oriented to a magnet in the stand, which when the life ring is released, the reed switch sends a trigger signal to the controller. But in other implementation, the life ring release detection can also be enabled via the motion sensor on the controller.

In certain implementations, multiple stands 300 may be provided at different locations along a shore, and different life rings 200 may be interchangeably mounted on the different stands 300. Due to the significance of the time-sensitivity and event notification assurance of emergency alerts, the life ring 200 and the stand 300 may work redundantly to sense the release of the life ring to transmit the alerting messages to the first responders. For example, the identifier may be used to identify a specific one of the multiple life rings 200 is being used in a rescue, and a location of a specific associated stand 300 may be provided to rescuers to allow for a better estimate of a location of the swimmer in distress.

Furthermore, an RFID reader or other life ring sensor 320 may be incorporated in a stand 300 to uniquely identify each life ring 200 and to avoid false positives of misidentifying one of the life rings 200. The identification device 280 may allow certain fail-safe safety features to be implemented to reduce a risk of the life ring 200 and the stand 300 from being tampered with, such as to prevent burglars from simulating the presence of the life ring 200 by placing a magnet near the stand 300. Once the life ring 200 is released from the stand 300, only that specific life ring 200 that is correctly identified by the stand 300 (e.g., containing a correct RFID tag or other ring device identifier 280) may be considered as “returned” when mounted on the stand 300 to prevent the life ring 200 from being inadvertently replaced with a conventional flotation device or another, nonmatching life ring 200 that does not have the correct identification device 280. Similarly, since both the life ring 200 and the stand 300 work concurrently and independently, a distressed swimmer cannot inadvertently deactivate the life ring 200 by contacting the life ring 200 with metal or magnetic materials, such as a watch or jewelry.

The life ring 200 may include one or more environmental sensors 270. For example, the environmental sensors 270 may include a moisture sensor to detect when the life ring 200 is thrown into water. In another example, the environmental sensors 270 may detect when the life ring 200 is removed from stand 300, such as a current sensor to detect when the battery 250 is not being charged or a pressure sensor to detect when the life ring 200 is not coupled to the stand 300. In another example, the environmental sensors 270 may include a motion sensor or an inertial measurement unit (IMU) to detect the release of the life ring 200 from stand 300 by sensing any movement on the life ring 200. The environmental sensors 270 may include sensors to detect aspects of the water, such as a temperature, current speed (e.g., horizontal movement), wave height or size (e.g. vertical movement), or other data that may be helpful to identify a location of the swimmer or a condition of the water around the swimmer. For example, the environmental sensors 270 may include a pressure sensor that measures attributes of waves against the life ring 200 to identify a frequency, direction, and magnitude of the waves.

In another example, the environmental sensor 270 may include an audio sensor such as a microphone that captures audio data. For example, the environmental sensor 270 may record audio data including verbal communications from a distressed swimmer and this audio data may be transmitted by the smart ring 200 via communication module 240 to a rescue official. In certain implementations, the controller 220 may determine when captured audio by the environmental sensor 270 corresponds to spoken content and may forward the identified spoken content. For example, the controller 220 may determine that the captured audio corresponds to spoken content when the audio has certain audio characteristics corresponding to spoken dialogue. In another example, the controller 220 may establish audio communications between the distressed swimmer and a rescue official using communications module 240 to forward audio from the swimmer captured by the environmental sensor 270, and receive audio from the rescue official that is outputted through the notification device 260.

The life ring 200 may include a notification device 260 to provide an indication to a swimmer, a rescuer, or a third party of a location of the life ring 200 in the water. For example, the notification device 260 may provide a visual indication of a location of the life ring 200, such as to output light that is visible or otherwise detectable by a device such as a search drone. For example, the light in notification device 260 may receive power from battery 250 when the environmental sensors 270 detect that the life ring 200 is removed from stand 300 and/or is positioned in water. In another example, the notification device 260 may output an audio alert such as a chirp or a whistle or a pulsing beep to assist a person in locating the life ring 200 within the water or when washed ashore. As described above, a speaker included in the notification device 260 may output recorded audio or audio received via communication module 240, such as to output audio commands from a rescue official to the distressed swimmer.

In another example, the notification device 260 may release a non-toxic fluorescent dye to indicate currents around the life ring and a trajectory of those currents, which serves as a visual aid for beach monitoring services and researchers who utilize cameras installed at high altitudes or drones to scan and surveil the surf-zones by obtaining the corresponding visual imagery. For example, the notification device 260 may include a pressurized waterproof enclosure that stores the non-toxic fluorescent material, and the fluorescent material may be released from the life ring 200 when the environmental sensor 270 detects that the life ring 200 is positioned in water or is near a distressed swimmer (e.g., when audio from the distressed swimmer is detected or when the motion analysis software detects human-influenced motion from the movement/orientation changes on the life ring 200 amidst the breaking waves exhibiting transverse and longitudinal motions), the non-toxic fluorescent material creating a colored trace of the life ring 200 as the life ring 200 moves through the water, thereby identifying the direction of motion of the life ring 200 and enhancing visibility for rescue operations, particularly during times of low light. Thus, in addition to providing alerts and notifications of distressed swimmer situations, the life ring 200 may provide rich data which is useful in studying the physical characteristics of dangerous currents in the surf-zone which may be highly valuable to a rescuer and other third parties. Furthermore, the detection of a distressed swimmer on the life ring can be detected from motion analysis software to detect human-influenced movements on the life ring.

Referring to FIG. 2E, the notification device 260 may include dye tablets positioned in a dye dispenser rack that is positioned under a lower cover enclosure of the plastic caddy 216 so that the dye dispenser rack may supply the dye tablets to the water. The life ring 200 may also have a capability to activate a linear actuator to push and dispense/release from a plastic rack a set of non-toxic fluorescent dye tablets to create a colored trace of the life ring 200 as it moves through the water and the water current itself, identifying the direction of motion of the life ring 200 and enhancing visibility for rescue operations, particularly during times of low light. The dye may be dispensed two or more times at different locations to generate a trail showing movement of the life ring 200 through the water. Thus, the dye may show any currents, such as rip currents.

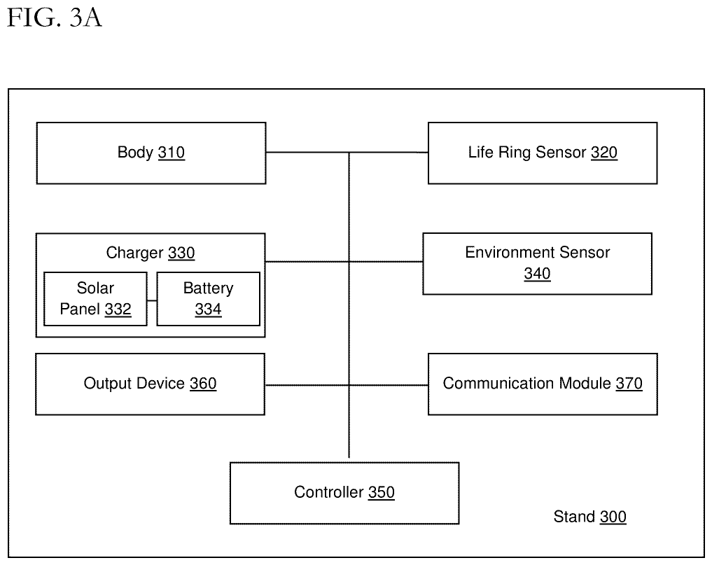

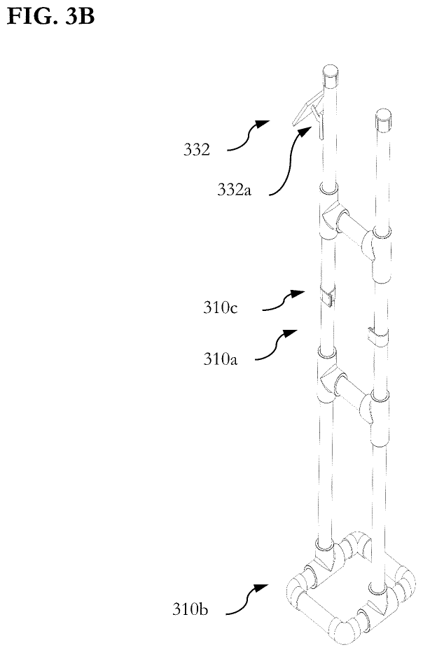

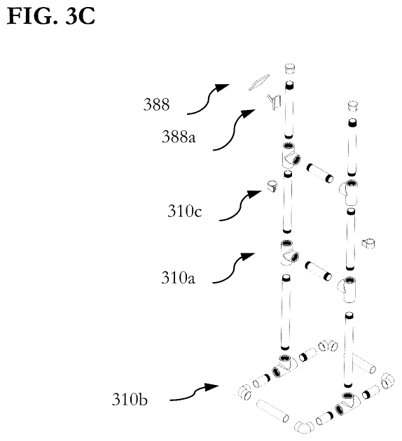

Referring now to FIG. 3A, the stand 300 to receive and charge the life ring 200 may include a body (or stand body) 310, a life ring sensor 320 to detect whether the correct life ring 200 is mounted on the stand 300 or removed, a charger (or stand charger) 330 to provide power to components to the stand 300 and to the life ring 200 when mounted on the stand 300, an environmental sensor (or stand environmental sensor) 340 to detect one or more attributes of the surroundings of stand 300, a controller (or stand controller) 350, an output device (or stand output device) 360 to output data such as an indication of a status of the stand 300 or the life ring 200, and a communication module (or stand communication module) 370 to exchange data with the life ring 200, user device 400, or third party device 102. It should be appreciated that the stand 300 may include fewer, additional, or different components.

The body 310 may include a caddy or other structure to support the life ring 200 when mounted on or otherwise stored on the stand 300. For example, the body 310 may include a hook that engages and positions a portion of the life ring 200. The body 310 may contact or otherwise engage a portion of the life ring 200 (e.g., a lower reed switch), such that the life ring 200 enters an activate state when removed from the stand 300. In another example, one of the body 310 or the life ring 200 may include a magnet and another one of the body 310 or the life ring 200 may include a sensor, such as a reed switch to detect the magnet.

The life ring sensor 320 may detect when the life ring 200 is present on the stand 300 and when the life ring 200 is removed from the stand 300. For example, the life ring sensor 320 may be a pressure sensor that determines whether a weight of the life ring 200 is present on a caddy included in the body 310. In another example, life ring sensor 320 may determine whether power from the stand 300 (e.g., by charger 330) is being supplied to the life ring 200, such as to determine whether a charging coil of the life ring 200 is positioned within a charging field generated by the stand 300 for wireless charging. In another example, the life ring sensor 320 may determine when life ring 200 is magnetically coupled to the stand 300. In another example, the life ring sensor 320 may be an array of photoelectric proximity sensors coupled with color sensors that is arranged in the circumferential profile of the life ring and determines whether a life ring 300 of said color is placed within the preconfigured proximity of the body 310. In another example, the stand 300 (e.g., via communications module 360) may receive sensor readings collected by the life ring 200 and may determine when the life ring 200 is removed from the stand 300 based on the sensor readings collected by the life ring 200, such as to determine when the life ring 200 is moving or when the life ring 200 is positioned in water. In another example, the life ring sensor 320 may determine when the life ring 200 is coupled to the stand 300 based on the sensor readings collected by the stand 300, such as by environmental sensor 340. In another example, the life ring sensor 320 may communicate to the environment sensor 340 which may be an overhead camera with an image processor that can be programmed via software to detect the presence of the life ring 200 by recognizing the top view contour of the life ring 200.

In certain implementations, the life ring sensor 320 may further detect whether a specific life ring 200 is mounted on the stand 300, such as to interface with the identification device 280 of the specific life ring 200. For example, the life ring sensor 320 may include an RFID reader that broadcasts an electromagnetic interrogation pulse and may receive a reply from the RFID tag in the identification device 280 of the life ring 200 when the life ring 200 is present on stand 300 or otherwise positioned within range of the stand 300. The reply from the RFID tag may provide identifying data associated with the specific life ring 200.

The charger 330 may include components for charging the battery 250 of the life ring 200 when the life ring 200 is mounted on the stand 300. For example, the charger 330 may receive power from an external source such as from an electrical utility company. The charger 330 may directly connect (e.g., via a metal extension contacting a corresponding metal pad of the life ring 200) and provide a charging current to the life ring 200. In another example, the charger 330 may include a charging station or pad through which an alternating current is provided to generate a magnetic field that fluctuates in strength due to the alternating current, and the changing magnetic field creates a charging electric current in an induction coil included in or coupled to the battery 250 of the life ring 200 when the life ring 200 is mounted on stand 300. In another example, the charger 330 may include a wire or coupling that is coupled to the life ring 200 when the life ring 200 is mounted on stand 300. The charger may further include a battery 334 that stores received power and supplies the stored power to the life ring 200, such as when a power supply to the stand 300 is interrupted or is insufficient to charge the life ring 200.

In certain implementations, charger 330 of the stand 300 may include components for harvesting solar energy to thereby function as an energy source for charging the life ring battery 250 even when the stand 300 is located in a remote location that is not connected to a power source. For example, charger 330 may include a solar panel 332 that uses the photovoltaic effect to convert light energy from the sun into an electric current. Additionally, the charger 330 may include a lens and/or mirror to direct light energy to the solar panel. The power generated by the solar panel 332 may be provided to life ring 200, such as to the battery 250, or may be used to power in the electronic components of the stand 300.

The charger 330 may further include the battery 334 that stores power generated by the solar panel 332 or received from another source and outputs this stored power as needed, such as when power provided by the charger 330 is not sufficient to meet the power needs of the life ring 200 and the stand 300. For example, the charger 330 may be configured as a solar powered charger 332 and may include a built-in lithium polymer (LiPo) battery 334, the electronics necessary to harvest the solar energy needed to charge the built-in battery, and a DC barrel jack to output a DC voltage to charge the life ring 200. For example, the charger 330 may supply 6 volts to life ring, and when solar panel 332 generates less than 6 volts, the battery 334 may supply the power generated by the solar panel 332. The solar powered charger 332 as a whole unit may be capable of functioning as an extended energy source in charging a system junction box, especially in situations of lower sunlight, such as prolonged cloudy days and night operations.

The environmental sensor 340 may collect sensor readings and may include a camera to capture one or more images or video of regions around from the stand 300. For example, the environmental sensor 340 may activate when the life ring 200 is removed to capture an image of a user removing the life ring 200 from stand 300. In certain implementations, the life ring sensor 320 may determine that the life ring 200 is removed from the stand 200 when the life ring 200 is present in a captured image, or the life ring sensor 320 may determine that the life ring 200 is moving when a position of the life ring 200 changes in different captured images. The environmental sensor 340 may further detect other information in the captured images, such as to identify a location of the life ring in the captured images, to determine conditions of the water where the life ring 200 is present, or to identify a person removing or otherwise holding the life ring 200. In one implementation, environmental sensor 340 may include a night-vision infrared wide-angled video camera to obtain, for example, image snapshots of the surf-zone and person who released the life ring 200, and a video of the surf-zone showing any details of the drowning scene.

The controller 350 may process information received from the third-party device 102, the life ring 200 or the control device 400, or information collected by the stand 300. For example, controller 350 may determine when the life ring 200 is removed from stand 300 and activate one or more components of the stand 300, such as life ring sensor 320, environmental sensor 340, or communications module 370. In another example, the controller 350 may activate charger 330 when life ring sensor 320 determines that the life ring 200 is positioned on stand 300. In another example, the controller 350 may activate environmental sensors 340 in response to receiving a command from third party device 102 or user device 400 to determine a location of the life ring 200 and local conditions based on images captured by the environmental sensor 340, and may interface with the communication module 370 to periodically or continuously transmit the location of the life ring 200 and the environmental conditions to the third party device 102 or user device 400.

The output device 360 may be a device to provide data to a user or other people around the stand 300. For example, the output device 360 may be a display that outputs usage instructions or other visual data. In another example, the output device 360 may include a speaker to output audio. For example, the output device 360 may output an alarm or may output usage instructions or other audio data when the life ring 200 is removed or otherwise disconnected from the stand 300.

For example, stand may incorporate a switching circuit module which is connected to a 120 dB waterproof alarm siren that is triggered when the stand 300 senses the release of the life ring 200. The release of the life ring 200 may be magnetically sensed upon a reed switch is activated when the life ring 200 is moved from its mounted position and is distanced from the stand 300 by at least 2 centimeters. Similarly, a hook shaped to match the curvature of the inner surface of the life ring is attached to the stand below the junction box to enable the life ring to be mounted onto the stand. The life ring 200 may also contain hole and plugs to accommodate magnets which enable the release event trigger in the Smart Life Ring.

The communication module 370 may transmit data to the life ring 200, user device 400, or to another communication device. For example, the communications module 370 may include an antenna that transmits signals to the life ring 200, user device 400, or to other communication device, and a processor to encode signals transmitted by the antenna.

In certain implementations, the stand 300 may include a system junction box that encompasses a waterproof (e.g., IP67-rated) electrical enclosure and an operational electronic system that includes the electronic components of the stand 300, such as life ring sensor 320, charger 330, environmental sensor 340, a controller 350, output device 360, and/or communication module 370. The electronic system in the junction box may be charged by connecting a waterproof power cable to a regulated power supply module in the box, while the other end of the power cable connects to the output port of the solar powered charger 332 included in the charger 330. The power cable may be fed through a waterproof cable opening which is installed on the bottom of the box. The regulated power supply module is connected to a LiPo charger to charge a battery 334 inside the box which is the primary power source. The battery 334 may power a wireless charging coil in order to wirelessly charge the life ring 200 via magnetic induction when the ring 200 is mounted on the stand 300.

In one implementation depicted in FIGS. 3B and 3C, the body 310 of stand 300 may be a modular structure and may be formed of smaller components and positioned as needed for beach safety needs. For example, the body 310 may be formed from multiple segments of tubes and connectors of a durable material, such as polyvinyl chloride (PVC). Thus, a stand/station structure for body 310 is designed to accommodate the mounting of the life ring and the tri-pole life-ring holder including the electronics/communication system. The entire stand can be built from off-the-shelf commercial PVC parts/components thus reducing manufacturing costs and durations. Most of these components of body 310 can be threaded to each other, while few components may be glued using strong adhesives and these go on the bottom of the stand to enable easy assembly. Once the components are assembled as shown in FIGS. 3B and 3C, the stability and sturdiness of the stand can be increased by filling the local beach sand, thus making the entire structure resistant to wind gusts. For example, the body 310 may include a platform 310a that extends vertically to provide a receiving surface for life ring 200 and/or UAV 700 to be discussed below, and a base 310b provided below the platform 310a and having a relatively larger horizontal area and/or mass to provide greater stability.

Furthermore, a modular body 310 may allow a user to position components at different positions according to the location of the stand 300 and attributes of the beach. For example, a solar panel mount 332a may be provided at different locations to accommodate a solar panel 332 of different sizes and to position solar panel 332 as desired, such as to position the solar panel 332 as a preferred position and orientation to optimize an amount of sunlight received at a specific beach. Furthermore, modular body 310 may allow a user to adjust the configuration of stand 300 according to needs of the beach community and features of the electronics/communications system to accommodate adequate power supply and charging of batteries. For example, a mounting clamp 310c may be moved to different heights or portions of stand 300 to position life ring sensor 320 and thus a location of life ring 200 at different portions of body 310, such as to position life ring 200 closer to users for easier access or to position an antenna for communications module 370 to improve communications performance, such as to point the antenna towards another communications node or other device.

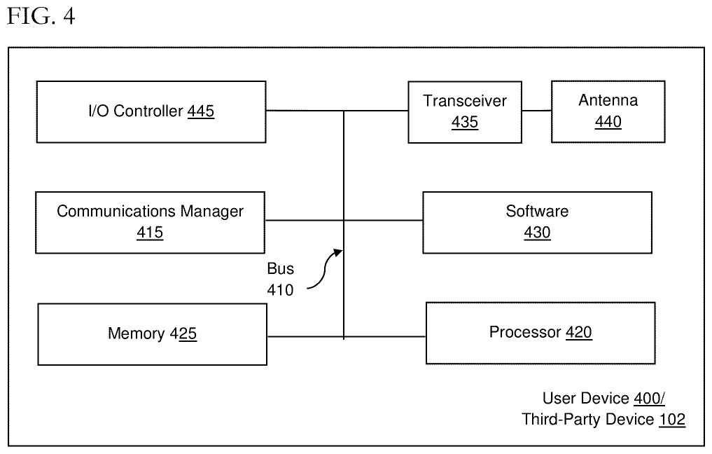

FIG. 4 shows a diagram of a user device 400 or a third party device 102 as described above with reference to FIG. 1. For example, user device 400 or third party device 102 may correspond to a computing device and communications device and may receive data from one or more of life ring 200 or stand 300, such as to receive an alert from stand 300 when life ring 200 is removed, to receive data from life ring 200 collected by environmental sensors 270, and to receive data collected by environmental sensor 340. In another example, the user device 400 may forward a command to life ring 200 and/or stand 300, such as to instruct a notification device 260 to output a sound or light to assist a rescuer in locating the life ring 200. User device 400 may include components for bi-directional voice and data communications including components for transmitting and receiving communications, including communications manager 415, processor 420, memory 425, software 430, transceiver 435, antenna 440, and I/O controller 445. These components may be in electronic communication via one or more busses (e.g., bus 410). User device 400 may communicate wirelessly with one or more of third-party device 102, smart ring 200, stand 300, or a base station associated with a communications network 101. In another example, components of device 400 may be included in the life ring 200 and stand 300. For example, controller 220, 350 may include one or more components of user device 400.

Processor 420 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 420 may be configured to operate a memory array using a memory controller. In other cases, a memory controller may be integrated into processor 420. Processor 420 may be configured to execute computer-readable instructions stored in a memory to perform various functions (e.g., functions or tasks supporting a beam-aware handover procedure for multi-beam access systems).

Memory 425 may include RAM and ROM. The memory 425 may store computer-readable, computer-executable software 430 including instructions that, when executed, cause the processor to perform various functions described herein. In some cases, the memory 425 may contain, among other things, a BIOS which may control basic hardware and/or software operation such as the interaction with peripheral components or devices.

Software 430 may include code to implement aspects of the present disclosure, including code to support a beam-aware handover procedure for multi-beam access systems. Software 430 may be stored in a non-transitory computer-readable medium such as system memory or other memory. In some cases, the software 430 may not be directly executable by the processor but may cause a computer (e.g., when compiled and executed) to perform functions described herein.

Transceiver 435 may communicate bi-directionally, via one or more antennas, wired, or wireless links as described above. For example, the transceiver 435 may represent a wireless transceiver and may communicate bi-directionally with another wireless transceiver. The transceiver 435 may also include a modem to modulate the packets and provide the modulated packets to the antennas for transmission, and to demodulate packets received from the antennas.

In some cases, user device 400 may include a single antenna 440. However, in some cases the user device 400 may have more than one antenna 440, which may be capable of concurrently transmitting or receiving multiple wireless transmissions, such as to communicate with different types of devices and/or via different communications network.

I/O controller 445 may manage input and output signals for device 400. I/O controller 445 may also manage peripherals not integrated into device 400. In some cases, I/O controller 445 may represent a physical connection or port to an external peripheral. In some cases, I/O controller 445 may utilize an operating system such as iOS®, ANDROID®, MS-DOS®, MS-WINDOWS®, OS/2®, UNIX®, LINUX®, or another known operating system. In other cases, I/O controller 445 may represent or interact with a modem, a keyboard, a mouse, a touchscreen, or a similar device. In some cases, I/O controller 445 may be implemented as part of the processor 420. In some cases, a user may interact with user device 400 via I/O controller 445 or via hardware components controlled by I/O controller 445.

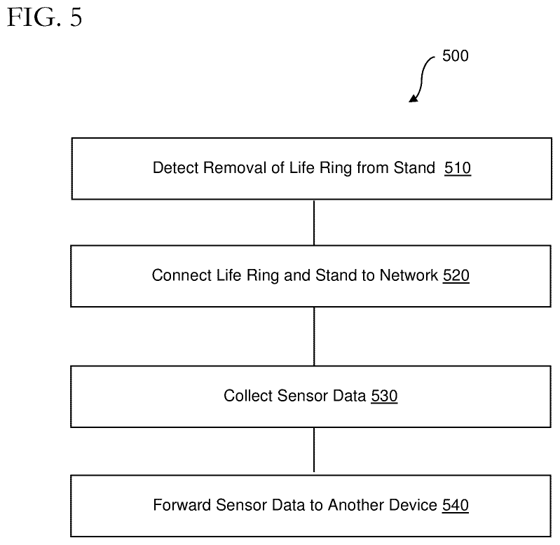

Referring now to the FIG. 5, the beach safety system 100 may implement an alerting and tracking method 500 that includes detecting release of the life ring 200 from the stand 300 (step 510), connecting to a communications network (step 520), collecting sensor data (step 530), and transmitting the sensor data (540) to another device.

As previously described, each of the stand 300 and the life ring 200 may individually sense the release of the life ring 200 from the stand 300 in step 510. For example, the stand 300 may include life ring sensor 320 that detects when the life ring 200 is removed from the stand 300. Similarly, controller 220 of life ring 200 may determine when the life ring 200 is removed from the stand 300, such as when the life ring 200 is not receiving power from the stand 300 or when the life ring 200 is moving relative to the stand 300.

Each of the life ring 200 and stand 300 may include a separate communications module to connect to network 101 in step 520. For example, communications module 240 of the life ring 200 and the communication module 370 of the stand 300 may communicate using a narrow band Internet-of-Things (NB-IoT) cellular network when the life ring 200 is removed from the stand 300. The life ring 200 and the stand 300 may communicate with first responders via the NB-IoT cellular network to transmit data in the form of messages in the subscribed IoT cellular service. A webhook may be assigned to each cellular device which receives the message transmitted by each device and relays it to a specified address of an IoT platform service by making a HTTP POST request, entirely configurable using the device manager feature on the IoT cellular service. Several factors such as data parameters, data format, and message transmission frequency can also be configured using inbound messages within each device by sending a message from the IoT cellular service to the device. Once a message is received by the IoT platform, the information in the received data message may be parsed and assigned into preconfigured individual data fields. The statuses and numeric measurements obtained from these data fields are displayed on individual stand-specific dashboards, one per pair of stand 300 and the life ring 200, in the form of color-coded widgets which enable the user to quickly obtain all the information within a short span of time. Examples of these widgets may include, for example:
(1) binary release statuses of the life ring 200 communicated from the life ring 200 and/or stand 300,
(2) solar charging status of the stand 300,
(3) manual turn on/off buttons to control the output device 360 (such as strobe light or alarm siren or play audio warning or instructional messages) on the stand 300 and the notification device 260 (such as light or audio alerts) on the life ring 200,
(4) manual setting of time period for the output device 360 (such as strobe light or alarm siren) on the stand 300,
(5) wireless charging transmission status of the stand 300,
(6) wireless charging reception status of the life ring 200,
(7) battery levels of the stand 300 and life ring 200,
(8) initial and current GPS location coordinates of the life ring 200,
(9) time history of the GPS location trajectory of the life ring 200 since the time life ring 200 is released from stand 300 overlayed on a satellite map of the beach,
(10) orientation and course of direction of the life ring 200,
(11) time history and current speed of motion of the life ring 200,
(12) time duration since life ring 200 was released from the stand 300,
(13) estimated time left to depletion of battery in the life ring 200,
(14) signal strengths of one or more communication modules 240 in the life ring 200 and one or more communication modules 370 in the stand 300,
(15) initial snapshot of the person who released the life ring 200,
(16) live video of the surf-zone scene possibly to obtain maximum information of the drowning event,
(17) navigable link to the current location of the life ring 200 and/or stand 300,
(18) time history of communication latencies in selectable window of communication messages from time of transmission by stand 300 or life ring 200 or user device 400 or third-party device 102 to time of reception by stand 300 or life ring 200 or user device 400 or third- party device 102,
(19) internal conditions (such as temperature, humidity, detection of leaks) of the junction box in stand 300 and enclosure 212 of life ring 200,
(20) external ambient environment (such as temperature, humidity, local wind magnitude, local wind direction) from the environmental sensor 340 of stand 300,
(21) real-value confidence status of detected dangerous currents analyzed from the time history of speed of motion of the life ring 200,
(22) real-value confidence status of the detection of the distressed swimmer securing the life ring 200; and
(23) estimation of distress level of the swimmer based on detection and analysis of human-influenced motion from the movement/orientation changes on the life ring 200 amidst the breaking waves exhibiting transverse and longitudinal motions.

In certain implementations, user device 400 may provide a master dashboard that includes several stand-specific dashboards which contains an overview of the status of each life ring deployed on a prespecified beach, the charging status of the batteries in the stand 300 and life ring 200, and battery levels of the stand 300 and life ring 200. Scripts/codes may be written in the IoT platform to enable detection of certain critical events such as release of the life ring 200 from the stand 300, charger malfunction, low battery levels, low signal strengths, offline states of communication modules 240 and 370 in life ring 200 and stand 300, etc. Based on the detection of such critical events, alerts may be issued, for example, in four different channels—texts, emails, phone voice calls, smartphone application notifications, and dedicated desktop computer software applications.

Text alerts are issued immediately when the life ring 200 is released from the stand 300 and contain critical information such as location (street name and address of stand), GPS coordinates of the life ring, redirectable link to a web mapping software to help user navigate to the initial and current location of the life ring 200, battery levels of stand 300 and life ring 200. Email alerts may be similar to text alerts in terms of message format, however, additionally also contain the initial snapshot picture of the user who had released the life ring 200. A smartphone application alerts appear as push notifications for personnel to get notified of life ring release events. Desktop computer software applications can be effectively monitored by personnel assigned to immediately take or issue actionable orders to the rescue teams. Several integrated tests of the stand 300 and life ring 200 systems have shown the average elapsed time duration is 1.5 seconds from the time the life ring 200 is lifted off the stand 300 until the earliest alert is received. Approximately, this results in a 97.5% shorter duration of an average time of 60 seconds from the time a bystander calls 911 until the time the 911 operator gets an accurate location of the drowning situation. The electronics firmware is developed and equipped to receive Over-The-Air (OTA) software updates via the IoT cellular service which enables the electronics firmware to be securely rewritten/reprogrammed remotely as per the customer's requirements without having a support/maintenance personnel visit the stand in person, which is valuable in customizing and integrating different customer's data requirements.

Accordingly, when the life ring 200 is separated from a supporting structure included in stand 300, an alarm such as a loud siren may be automatically activated and may continue intermittently for several minutes as an alert to people nearby that an emergency drowning situation may be in progress. At the same time as the life ring 200 is lifted from the support structure at stand 300, communications such as text, email, and smartphone notification alerts may be automatically issued to all personnel approved for notification by local authorities such as lifeguards, fire rescue service, police, and beach safety service. Both the texts and emails consist of information that is vitally important for prompt rescue, such as (1) GPS coordinates of the initial location of the life ring, (2) a clickable link (URL) which redirects the user to a web mapping software such as Google Maps® to navigate to the current location (via real-time transmission of GPS coordinates) of the life ring 200. This functionality enables first responders to go to the current actual location of the life ring 200 and not its initial location, while a clickable link may redirect the user to a stand-specific software dashboard showing the time history of motion and location trajectory of the life ring 200, a battery level status of both the smart stand battery 334 and smart life ring battery 250, elapsed time duration since the life ring 200 was released from stand 300, and estimated time duration of the remaining operational time to depletion of battery 250 in the life ring 200. Subsequent to issuing these alerts, the stand 300 acquires visual snapshots of the surf-zone scene and transmits this video data to the cloud service which is displayed on the stand-specific dashboard. Each stand-specific dashboard is part of a master dashboard which contains the status of each life ring 200 deployed on a prespecified beach, which additionally displays the charging status of the batteries in the smart stand 300 and smart life ring 200. Authorized personnel can access these dashboards on web pages via URLs and also on smartphones via dedicated applications. The alerting technology is also made customizable for rescue services by having dashboards that are customized to be compatible with their dedicated desktop computers including audible alerts upon release of life rings.

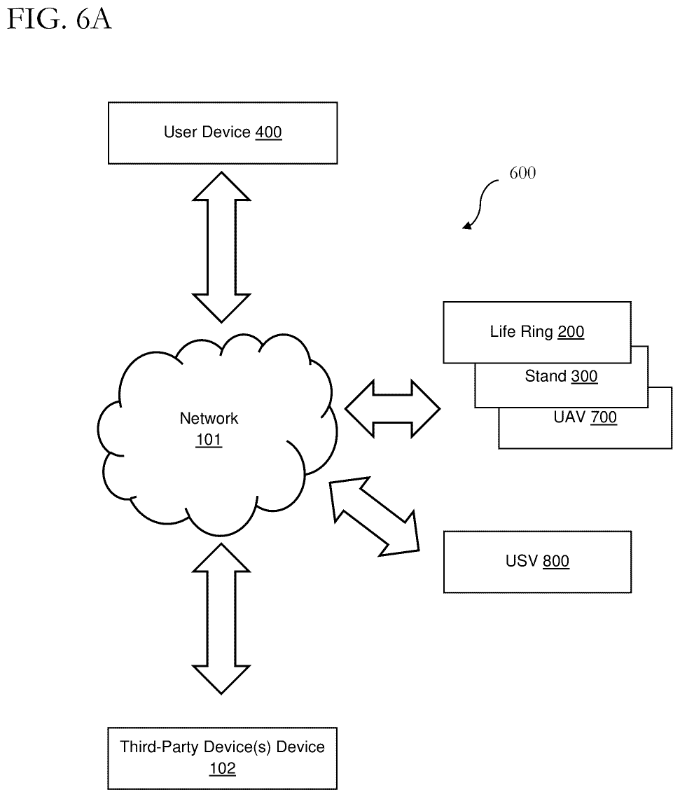

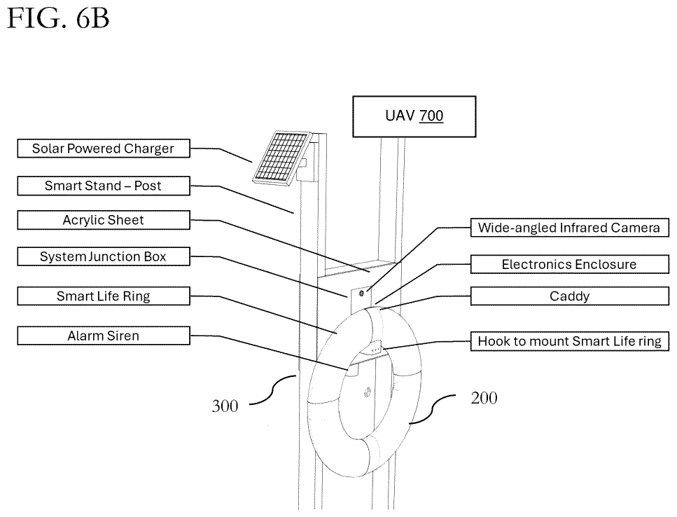

Referring now to FIGS. 6A and 6B, a beach safety system 600 corresponding to beach safety system 100 of FIGS. 1A and 1B that includes life ring 200 and stand 300 may further include one or more additional components that communicate with and/or interact with life ring 200 and stand 300. For example, a beach safety system 600 may include one or more of an unmanned aerial vehicle (UAV) 700, commonly referred to as a drone, and a an unmanned surface vehicle (USV) 800. The UAV 700 and USV 800 may communicate with the life ring 200 and/or stand 300 via network 101 or may further communicate with user device 400 and/or third party device 102. In certain implementations, the UAV 700 may dock at or otherwise physically connect to the stand 300. For example, the stand 300 may include a platform where UAV 700 docks when not in use. When sitting on the platform, the UAV 700 may directly connect to the stand 300 to receive power (e.g., from charger 330) and to exchange data via communications module. For example, UAV 700 may receive instructions on when and where to fly along a shore, and after returning to the stand 300, the UAV 700 may output data collected while flying. In another example, the UAV 700 may wirelessly connect to stand 300 when resting on a platform, such as to receive power through inductive charging or to exchange data with stand 300 through wireless communications.

Network 101 in beach network 600 may include various communications interfaces to have seamless internal and external communication, such as 1) a high bandwidth short-range communication channel (such as WiFi or equivalent to IEEE 802.11 wireless standard communication technology), enabling high speed data transmission and reception between the vehicle and ground stations; and 2) a low bandwidth long-range communication channel (such as radio or equivalent to IEEE 802.15 wireless standard communication technology) to support bidirectional communication between the unmanned vehicles of UAV 700 and USV 800 and a commercially available handheld radio controller on the shore such as third-party device 102 or user device 400. Additionally, the UAV 700 will also have a cellular communication channel, such as 3GPP standards (LTE and 5G) or any other mobile communication standards in the context of fixed wireless access (FWA) (OpenRAN, Tarana's G1, Non-3GPP Interworking Function (N3IWF), or 3GPP2), which enables data transmission and reception over the internet to facilitate remote communication with the beach rescue departments. The rip detection system may remain in radio communication with the beach community, even if the cellular service is unavailable. The communication between the UAV 700, stand 300, and user device 400/third party device 102 may be unified where all the communications will happen in the back-end. The operator will be presented with a software user interface which will be made accessible via smartphone/computer with user device 400/third party device 102. The user interface will act as a front-end that can accept mission input, generate operational plans, and output mission reports.

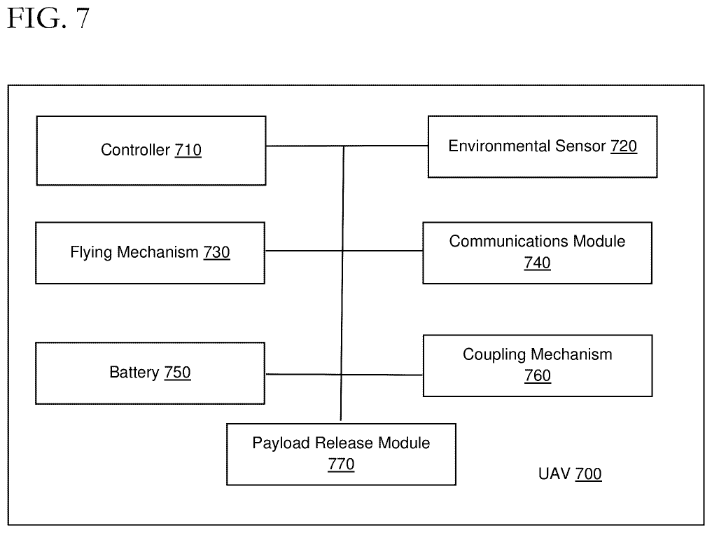

As depicted in FIG. 7, a UAV 700 may include various components to perform controlled motion along a shore or other water regions near the stand 300, and to collect and process sensor data while moving to identify potentially hazardous conditions, such as a rip currents and dangerous marine wildlife. For example, the UAV 700 may include a controller (or UAV controller) 710 to manage movement and other operations of the UAV 700 and to process information collected by the UAV 700 to identify dangerous water conditions; an environmental sensor (or UAV environmental sensor) 720 to detect information regarding an environment around the UAV 700, such as to detect information regarding a location of UAV 700 and regarding water conditions; a flying mechanism 730 to propel the UAV 700 such as one or more motors to provide a propulsion force; a communications module (or UAV communications module) 740 to forward data collected by the environmental sensor 720 or processed by the controller 710 and to receive commands from the user device 400 or third party device 102; a battery (or UAV battery) 750 that may to receive and store power from the stand 300 that is used to operate the other components of the UAV 700; and a coupling mechanism 760 to couple the UAV 700 to the stand 300 when not operating. It should be appreciated that the UAV 700 may include fewer, additional, or different components.

The controller 710 may include system hardware for UAV control called the flight controller (FC), flight controller board (FCB) or autopilot. Common UAV-systems control hardware typically incorporate a primary microprocessor, a secondary or failsafe processor, and sensors such as accelerometers, gyroscopes, magnetometers, and barometers into a single module. The controller 710 may process information received from the third-party device 102, stand 300 or the control device 400, or information collected by the UAV 700. For example, controller 710 may receive a command to travel to a particular location from the stand 300, may determine a flight path to the specified location, and may activate the flying mechanism 730 to move the UAV 700 to the specified location and then return the stand 300 or other location. In another example, the controller 710 may manage the flying mechanism 730 to cause the UAV 700 to return to the stand 300 or other another stand 300 or other charging location when the battery 750 is below a prescribed charging level.

The controller 710 may activate the environmental sensor 720 when UAV 700 is flying to collect information regarding water weather conditions and may process the collected sensor information to identify hazardous conditions, such as rip currents, as described in greater detail below. Controller 710 may activate environmental sensors 720 in response to receiving a command from third party device 102 or user device 400 or may automatically activate environmental sensor 720 when travelling to collect data regarding a region of water, such as to images captured by the environmental sensor 720, and may interface with the communication module 740 to periodically, intermittently, or continuously transmit the environmental conditions to the third party device 102 or user device 400.

The environmental sensor 720 may collect sensor readings and may include a camera to capture one or more images or video of regions around from the UAV 700. For example, the environmental sensor 720 may further detect other information in the captured images, such as to determine conditions of the water, atmosphere, or beach area near a travel path of the UAV 700. In one implementation, environmental sensor 720 may include a wide-angled video camera to obtain, for example, image snapshots of the surf-zone to identify a location of life ring 200 and a video of the surf-zone showing any details of the scene, such as a movement of the life ring 200 within the water. As previously described, the environmental sensors 720 may also include sensors such as accelerometers, gyroscopes, magnetometers, and barometers that are used by controller 710 when controlling a flight of the UAV 700, such as to determine a location, orientation, and movement of the UAV 700. It should be appreciated, however, that other types of environmental sensors 720 may be included in UAV 700, such as a sensor to collect and process a water sample, an audio sensor to identify a distressed swimmer, a wildlife sensor, etc.

UAV 700 may have a variety of airframe and motor configurations. For example, UAV 700 may be configured as a flying wing or blended wing body design, or may be a quadcopter or a multirotor designs with six or more rotors rotated by electric motors as flying mechanism 730 and driven by battery 750. For example, the battery 750 may be lithium-polymer batteries (Li-Po). In another example, battery 750 may not drive flying mechanism 730, and instead, flying mechanism 730 may include internal combustion or jet engines. Controller 710 may include UAV actuators or may otherwise control the rotational speeds of the motors linked to engines and propellers.

The communication module 740 may transmit data such as information on the life ring or detected water conditions to the life ring 200, stand 300, user device 400/102, or to another communication device. For example, the communications module 740 may include an antenna that transmits signals and a processor to encode signals transmitted by the antenna. In certain examples, communication module 740 may support text on AI/ML-enabled, real-time, ground truth validated rip detection by UAV and also beachgoer smartphone application for automatic alerts and guidance near dangerous current zones, such as send notifications of detected rip currents or distressed swimmers.

The UAV 700 may further include a coupling mechanism 760 such as physical hook or a magnetic coupling to couple the UAV 700 to the stand 300 when not operating. Thus, the UAV 700 may be attached to the stand 300 when charging and to prevent the UAV 700 from being damaged by wind. In certain implementations the UAV 700 may be contained in an enclosure fixed atop the stand 300 which will have a top motorized cover/lid that can automatically open when the UAV 700 launches, lands, and docks based on the commands from the controller 710 through communications module 740. In certain implementations, the top surface of the top cover/lid of the enclosure for UAV 700 may include an embedded larger solar panel for higher energy efficiency and higher charging power needs.

In certain example, UAV 700 may acquire video and still images and may make real-time detection of currents and dynamically assess them deciding if they are not rips, weak rips, medium rips or strong rips. These assessments are enabled by learning-based models which are trained, via supervised learning, on ground truth rip current data measured by USV 800. The trained model is deployed in the UAV, embodied as a software agent, to detect and classify the rip currents as it is flying over them, and transmit its detections, as it makes them, to beach personnel for their awareness. In known rip current detection systems, learning-based models to detect rip currents lack validation by ground truth data and are only based on limited visual data. Thus, specific hardware modifications and development of new Al/ML software, trained on watercraft-measured rip current data by USV 800, may enable more accurate real-time rip detection by the UAV 700.

In certain examples, the UAV controller 710 contains an onboard flight controller (FCU) for independent motion control to maintain stability in gusts. The environmental sensors 720 may include a 2-axis, high resolution, 4K camera system with a wide-angle lens, and controller 710 may include single-board Nvidia Jetson Nano computer to perform onboard real-time image processing of video data and storage of image files. Thus, controller rip detection reports may be automatically created and updated by controller 710 using rip report software, throughout each UAV flight. Each report provides GPS coordinates of each rip location, trajectory from the shoreline, extent to current dissipation, the spatial velocity variation throughout the rip, and a map of the entire rip zone for each rip detection. Using this measured data, controller 710 may create a rip current boundary zone map superimposed onto the local beach map. At the end of a beach surveillance mission controller 710 may create maps of the rip zone for each rip detection.

In certain example, controller 710 may be coupled to a software user interface in the form of a smartphone application and a website enables access to these maps by the beachgoing public. A beachgoer may be automatically alerted if their GPS coordinates place them in or near a rip zone. Standard visualization software may be used to highlight the prominent shoreline features and the beach access paths so the user can easily orient themselves on the beach with respect to the dangerous zones. The interactive map in the software user interface may also automatically update and orient itself to the smartphone's orientation based on the internal compass, which can be calibrated if necessary, to allow the user to easily perceive the nearest access points, corresponding paths to take, and local dangerous conditions. The beach goers may be directed, based on their location, to a safer swimming location. As a safety feature, an awareness alert will also be transmitted to beach safety personnel that swimmers are possibly near a dangerous current zone at an unguarded beach and safety measures may need to be taken.

UAV 700 may implement a real-time solution for rip current detection from a mobile sensor platform. The real-time solution for UAV 700 may include 1) processing in real-time the acquired UAV video/image data and 2), transmitting in real-time the locations and intensities of the detected rip currents to the beach officials to provide a mobile surf-zone rip current detection water-borne platform. The USV 800 may be used to provide ground-truth data to validate visual rip current detections and enable higher accuracy rip detection models. The beach safety system 600 may be capable of autonomously monitoring the coastal zones along the beach, identifying and measuring rip currents, and alerting in-situ beach public and safety personnel who may then take necessary actions to protect swimmers. Thus, the data collection and processing operations of the UAV 700 in connection with data collected by USV 800 allow autonomous beach monitoring, correlation between beach topography and rip current occurrence potentially leading to localized prediction of dangerous currents. The beach safety system 600 integrates diverse components of multidisciplinary research that span design, modeling, control, communication, software, mechanical and electrical engineering, artificial intelligence, machine learning, and vehicle hydrodynamics.

For example, controller 710 may use artificial intelligence and machine learning techniques to process images or videos of a water region captured by environmental sensors 720 to identify dangerous conditions such as rip currents that could potentially carry a swimmer away from a shore and into deeper water. For example, the controller 710 may compare image attributes such as color, brightness levels, edges, contours, and reflectivity of different portions of a water region to identify wave shapes and movement patterns or a lack of waves within the region. This information can be compared with rip currents and other water movement patterns directly sensed by the USV 800 when moving through the water region or other areas. In one example, the controller 710 can filter the images to identify image attributes at different locations within a region and analyze the images attributes and changes therein in view of water movement patterns directly sensed by the USV 800 within the same or a similar region to identify image attribute patterns associated with certain water movement patterns. For example, the controller 710 can compare image attributes associated with a rip current within a water region and other water movement patterns within that region, such as common waves and other water movement due to the underwater topology, regional environment and other beach conditions.

The beach safety system 600 may include, for example, UAVs 700 provided intermittently along a shore, such as to provide a UAV 700 per every 10-mile beach segment; a USV 800; onshore UAV ground stations such as stand 300 provided intermittently along a shore, such as to provide two such UAV-storable stand 300 per every 10-mile beach segment, a user software interface, and a handheld controller.

UAVs 700 may be customizable in terms of including a powerful lightweight single board computer (SBC) that is capable of performing real-time onboard computer vision processing and running pre-trained AI/ML models. The UAV's onboard flight controller unit (FCU) is comprised of an inertial measurement unit (IMU) and a global positioning system (GPS). The FCU will be responsible for independent motion control to maintain stability in hovering mode in the presence of winds or gusts. Additionally, the FCU may be capable of receiving high-level waypoints from the SBC based on pre-determined flight paths to enable autonomy. In certain examples, the UAV 700 may possess Level 7 wind resistance and can withstand up to 38 mph (or 61 km/h) wind speeds. The UAV 700 may be equipped with a 2-axis high-resolution 4K camera system and a wide-angled lens to obtain an adequate field of view of the beach surf-zone. At an altitude of 250 ft and with a straight-down camera angle, a single frame can cover up to 230 ft of length along a beach. The UAV 700 may have an additional 150 ft of altitude capability and 60 degrees of variable camera angle to extend this length. These measurements show that the UAV 700 may be capable of acquiring images and videos along long stretches of the beach. Additionally, the UAV 700, when equipped with lightweight flow and depth sensors, may also obtain the ground truth measurements of a rip channel. In certain examples, a fully charged UAV can operate continuously for 30 minutes in the GPS mode of operation and fly at speeds up to 22 mph. Due to the limited operational duration of the UAV 700 from battery 750, the flow/depth sensing functionality can only be used on demand when there is a necessity to measure the physical characteristics of a rip channel of interest, perhaps of severe intensity or near frequently accessed beach access points. On the contrary, considering the high transit speed of the UAV 700 compared to the USV 800, the UAV 700 can be directed to rapidly scan large segments of a beach to efficiently utilize its operational runtime.

In other examples, the UAV 700 may include an embedded payload release module 770 on the UAV that enables provision of life-saving rapid rescue of distressed swimmers by delivering a floatation device or life ring 200 to the identified location immediately. Furthermore, with an onboard vision processor SBC as the controller 710 on the UAV 700, autonomous prediction of the distressed swimmer's location is possible via real-time analysis and determination of the beach visitors' gestures and/or body's orientation gaze vector convergence from the snapshots/video obtained from UAV 700.

In one example, the UAV 700 may also be equipped with an environmental sensor 720 that includes infrared (IR) thermal imaging cameras to assist in rapid and accurate detection of distressed swimmers during night times and deliver GPS-tracking enabled floatation devices. Additionally, with machine learning-trained models, the IR camera-equipped system may be enabled to detect possible dangerous marine wildlife such as jellyfish on the shore and predatory species in the near surf-zone.

In certain examples, an environmental sensor 720 may include a water quality sensor embedded within the UAV 700 to provide in-situ analysis of surf-zone water tests thus determining if it is safe for the beach public to enter the water. Quick automated tests can be carried out to determine the pH, TDS, and turbidity of the sampled water, and detect chemicals, oil spills, and any other substance or pollutant which may cause discomfort or harm to the swimmer's internal or external body condition, and to then issue alerts to the authorities who can determine if further detailed tests are required. For example, a water sample collector may be attached to the bottom of the UAV and can extract up to 500 ml of seawater from the surf-zone for automatic analysis and test of water quality with robotic equipment installed in the secure storage cabinet of the stand 300 or other location.

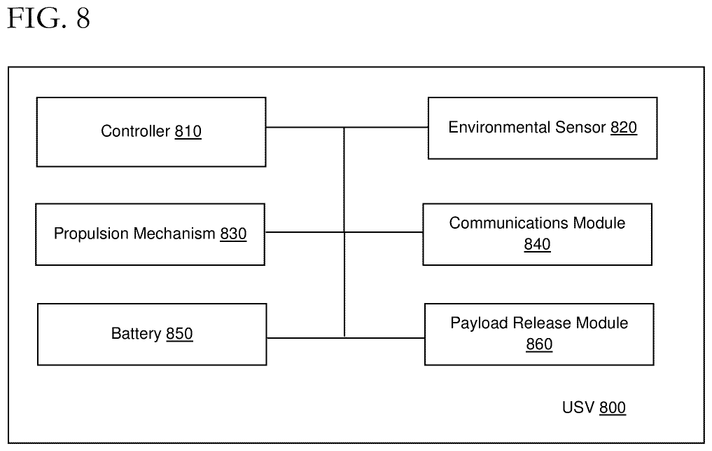

As depicted in FIG. 8, USV 800 may be equipped with a controller (or USV controller) 810 and environmental sensors (or USV environmental sensors) 820, such as flow and depth sensors to be capable of obtaining ground truth measurements of dangerous currents along the surf-zone. USV 800 may be equipped with a propulsion mechanism 830, such as two submersible thrusters enabling differential steering control and extremely rapid change of heading and also for maintaining position and orientation in a wave environment. Position and orientation control of the USV 800 in waves by the controller 810 may be extremely valuable for operation near obstacles such as piers or jetties where rips often occur. USV 800 may be designed to have a special body to be capable of successfully returning to an upright orientation following a temporary capsize in breaking waves, such as to have a body that is specially weighted and shaped to right itself in waves. USV 800 may be equipped with environmental sensors 820 that include flow sensors and an acoustic depth sensor to enable measurement of flow magnitudes and depth variations as USV 800 transits across a rip. USV 800 may be additionally equipped with environmental sensors 820 that include IMU and GPS sensors. In certain implementations, USV 800 may be equipped with environmental sensors 820 that include a 4K high-resolution video camera, high-resolution infrared thermal imaging camera, and underwater acoustic imaging sonar to detect/avoid/rescue swimmers as per situational demands and to detect dangerous wildlife in the surf-zone. The USV can also detect dangerous marine wildlife and swimmers nearby with the onboard cameras and underwater acoustic imaging sonar. .In certain implementations, USV 800 may be equipped with environmental sensors 820 that include water sampling equipment to continuously test the water for pH, TDS, turbidity, chemicals, oil spills, and any other substance or pollutant which may cause discomfort or harm to a swimmer's internal and external body condition, and then issue alerts to the authorities who can then determine if further detailed tests are needed and if public access to the detected regions should be blocked. Controller 810 may include an onboard FCU and SBC enable high speed data processing with heavy computation power and data storage. The USV 800 may include fasteners and attachments made of 3D-printed PETG/ASA/Nylon plastic or 316 grade stainless steel, to avoid any marine corrosion. A fully charged USV 800 can continuously operate for 36 hours making charging throughout the day unnecessary. While the UAV 700 may be capable of selectively measuring the flow velocity and depth of a rip channel, USV 800 leverages its prolonged operational duration (of nearly 36 hours) when compared to the 30 minutes of runtime on the UAV 700. This provides operational benefits such as continuous data collection from the USV 800, thus avoiding the necessity of retrieving the unmanned vehicle to change/charge the batteries frequently, which would be the case with the UAV 700. Furthermore, USV 800 may include a communications module 840 to transmit data sensed by environmental sensors 820 and to receive commands, such as to direct a movement pattern of the USV 800. In certain implementations, the USV 800 may be directed to travel to a distressed swimmer or to a location of a deployed smart life ring 200 to collect information on the swimmer or an adjacent region or to provide assistance, such as to provide additional buoyancy to the swimmer or to allow the swimmer to communicate with rescue officials using a communications interface provided on USV 800. In certain implementations, the USV 800 may be equipped with handles conveniently located to be latched or held or grasped by the distressed swimmer for prompt initiation of rescuing the distressed swimmer by the USV 800. In certain implementation, the USV 800 may be equipped with one or more payload release module 860 that can release a life ring 200 or a life preserver floatation device to a distressed swimmer or water-soluble fluorescent dye pouches to trace the trajectory of a water current.

As previously described, UAV 700 may communicate with stand 300, and as depicted in FIGS. 3B and 3C, stand 300 may be implemented as a cost-effective ground station to enable autonomous launch and retrieval of the UAV, charging the UAV, and also provide secure storage of the UAV. This stand 300 is made of commercially available PVC pipes of schedule 40 which can be installed on the shore and filled with beach sand to reduce construction costs and increase the stability and sturdiness of the structure. The stand 300 can withstand windspeeds up to 70 mph. These stand 300 include, for example, 1) an overhead in platform or compartment 310a to accommodate launching, retrieving, charging, and storing of the UAV 700, and 2) environmental sensors 340, such as an anemometer to measure wind magnitude and direction. Each stand 300 may include various inbuilt mechatronics system to automatically open/close these compartments, read the measurements from the anemometer and enable launching of UAV 700. The base of the compartment 310a may contain a visual aid landing system such as QR code or light/IR patterns to provide visual guidance for the UAV 700 to detect and orient itself prior to landing. The base of the compartment 310a may also contain electrical contact pads connected to a charger powered by a solar panel 332 which will be installed at the compartment 310a. The stand 300 may be secured with both locks and a tamper-proof emergency alerting system.

Controller 810 of USV 800 may be able to store large data files consisting of rip current measurements. Similarly, controller 710 of UAV 700 may be able to store large data files consisting of video/images of the surf-zone. The USV 800 will have the capability to communicate its GPS coordinates at any time to the UAV to enable synchronized data collection. Both the vehicles can be manually operated using a handheld radio controller on the beach. Built-in programmable displays on the handheld controller will enable the user to view in real-time the flow intensities and depth variations across the rip being measured by the USV 800, and real-time aerial imagery from the UAV 700, via high-speed telemetry. An extended version of the telemetry from the USV 800 and UAV 700 can be viewed on a portable computer. With the aforementioned communication interfaces, the above data/information flow between the vehicles, Pilot In Control (PIC), stand 300 and user device 400/third party device 102 can be achieved. The UAV 700 will be equipped with autonomous flight capabilities. The autonomous operation of the UAV can be overridden by authorized personnel to enable manual radio control during applicable or demanding circumstances.

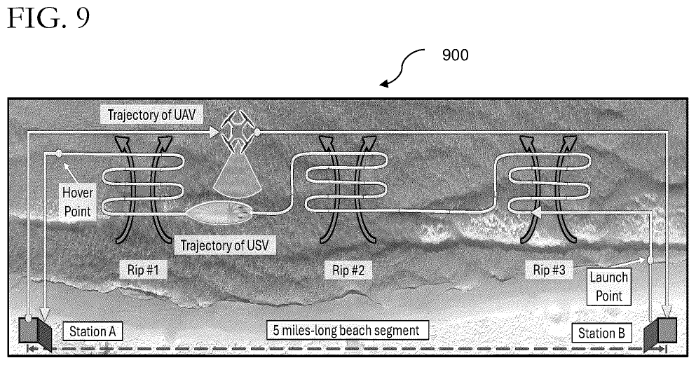

For example, as depicted in map 900 of FIG. 9, UAV 700 and USV 800 may have separate trajectories along on a 5 miles-long beach segment to investigate three separate rips, with the UAV 700 and USV 800. For example, as depicted in FIG. 9, UAV 700 may travel parallel to a shore region between two stands (or stations) 300. Similarly, USV 800 may travel parallel to a shore region between two stands (or stations) 300 but may turn to travel along respectively closer or further parallel paths of the beach when a rip is detected to determine how far the rip extends from the beach.

Operation of the UAV 700 and USV 800 may include a preliminary step of having an FAA Part 107 certified Pilot In Control (PIC) evaluating that it is safe to perform data collection or tests with the UAV 700 and USV 800. The operator, based on visual observations (visibility conditions, no swimmers in the water or people nearby on the beach) will decide if it is safe to launch and operate the vehicles. The launch of the UAV 700 then proceeds if anemometric measurements indicate that it is safe to launch. All UAV 700 operations will adhere to the new FAA rule for safe operations over people. If the operation involves the use of USV 800, then the environmental conditions are evaluated by the operator before launching the USV 800 into the water. The USV 800 is restricted to being operated only in green, yellow, and single red-flag conditions, but not double-red flag condition. After launch, data collection by the UAV 700 and USV 800 commences. These prechecks can be carried out within the visual far line of sight, such as from a nearby lifeguard tower. As more autonomous UAV 700 operations are being commercialized and also based on future potential FAA waivers which support autonomous operations, the beach operations can be foreseen remotely too by accessing the video feed of the UAV 700 and the ground station or stand 300.

Operation of the UAV 700 and USV 800 may include a 1. System customization operation, and 2. Rip detection operation. For example, the system customization operation may include UAV 700 having a pretrained visual rip-detection model on its SBC. Prior to implementation of the technology on a beach to carry out routine scanning of rip currents, each beach is studied for its environmental conditions and visual features which vary in different ranges between beaches in various geographical extents. Hence, each installed model must be updated prior implementation and beginning of every season post implementation, with the contemporary environmental features of the beach. In order to achieve this, both the UAV 700 and USV 800 will be used to scan the surf zone and collect the visual features and ground truth measurement data (from flow and depth sensors), respectively. In order to maintain consistency in acquired data from UAV 700 and USV 800 with respect to environmental conditions, the UAV 700 may simultaneously follow the USV 800 during its test duration. This will ensure that the data acquired from UAV 700 and USV 800 are already spatially associated. The UAV 700 may be retrieved several times to change the battery, perhaps after every 30 minutes of flight time during which the USV 800 may be put into a hover mode. To ensure the diversity in the video data accumulated by the UAV 700, the vehicles may be subjected to different beach conditions such as lighting, fog, different times of the day, etc. All the measurement data will be logged on board using memory storage cards in the SBCs. One pass of the UAV 700 and USV 800 scanning a beach segment conclude one data measurement beach operation. Throughout the operation, UAV 700 and USV 800 are either under the manual control of the operator or under autonomous operation. The operator also has the option to engage autonomous capability (auto-pilot mode) in UAV 700 and USV 800 midway during the operation by toggling the option from the software user interface. This option also enables the operator to mark the regions to be scanned by the UAV 700 and USV 800 in user interface which is then automatically fed to the unmanned vehicles as auto-pilot mission objectives. At the end of each operation, UAV 700 is retrieved and stored back in the secure cabinet, while the USV 800 is rinsed with fresh water, and stored in the beach facility. The collected data are temporally correlated followed by which a training algorithm will utilize the ground truth measurement data from the USV 800 to increase the visual rip detection accuracy of the learning model.

During the subsequent detection operation, with the updated visual rip detection model, the UAV 700 may be programmed to routinely and autonomously carry out missions which will involve launching and landing at ground stations and transiting through the beach segment to detect rips. These missions are preprogrammed by the operator prior to the launch of the UAV 700 via the software user interface. Autonomy plays its role in three stages of operation—during 1) launch, 2) transit, and 3) retrieval of the UAV. The launch and retrieval of the UAV 700 will be supported by ground stations on the beach. Autonomous capability on the UAV 700 enables it to follow the shoreline at a specified distance to traverse a path from the launch station to the retrieval station. Existing UAV path planning models can be leveraged to accomplish this task. The UAV 700 can autonomously transit to the station or stand 300's GPS coordinates, hover over the station, wait for the cabinet to open, descend to the landing zone on the station and use visual aid/guidance landing system (such as QR codes) to align and orient itself to the charging pads in the cabinet for the initiation of the UAV's battery charging. A major requirement of FAA's category 4 of drone operations is to not be flown (manually/autonomously) beyond the Line-of-Sight. However, a recent FAA rule change permits submissions of waiver request for Beyond Line-Of-Sight (BYLOS) operations. A temporary constraint of having the UAV within the line of sight of the operator can be implemented until the waiver is approved for a given location. A major requirement of the UAV 700 has been to not be flown (manually/autonomously) above humans. A recent FAA rule change permitting a waiver for BYLOS operations makes this restriction no longer applicable. The UAV 700 can be flown outside the swimmer zone, thus avoiding intersection of its path with any beach public and swimmers, while pointing the camera to the surf-zone. With the completion of a beach operation, the software user interface can then autonomously generate reports and communicate to the operator in any requested format.

After collecting images and other sensor data, the UAV 700 bases its decisions on features extracted from visual data. Most research studies predominantly depend on the prominent features to visually detect rip currents. Rips are also possible in the absence of waves as a result of beach morphology and obstacle flows when there are no obvious visual features to be detected by the UAV 700. However, the USV 800 is capable of detecting rips that have no visual features by measuring flow and depth data, and the USV-measured flow data enables identification of subtle features that may actually be detectable, such as sediment outflows. Beach safety system 600 makes the best of both vehicles capabilities by using the large detection range and fast surveillance of the UAV 700 with the precise flow and depth measurement performance of the USV 800. The combined usage of both USV 800 and UAV 700 results in a single integrated data collection system which increases the validity of the data and decreases the necessity to laboriously label the visual data of rips or even classify them into various magnitudes.

Learning-based rip detection software may be used by the UAV 700. The sensor data collected by the USV 800 will be accumulated to generate a surf-zone rip current ground truth database. Algorithms/heuristics implemented in data processing software can then perform computerized analysis and classification of every raw measurement data in the generated database and accordingly label it as safe and moderate/dangerous rip current zones based on flow velocity measurements. The data analysis approach may incorporate measured vehicle dynamics and incident wave dynamics to extract the rip current velocity in variable external conditions. The UAV video imagery dataset, consisting of image frames and timestamps, will then be associated with the quantified ground-truth measurement dataset, via temporal correlation. A machine learning model is then trained offline for UAV rip detection based on input consisting of only visual data from the surf-zone. The learning model will follow contemporary architecture, with a focus on producing lightweight ‘yolov8n’ models which can be deployed on the UAV 700's SBC included in controller 710 for onboard image processing and rip detection. The trained model can then be incorporated on the SBC's local software thread to concurrently read the video frames from the UAV's camera, input them to the trained model, infer the detection results from the model, and relay the result to the operator via telemetry. For power consumption reasons, this software thread may be queried when the UAV 700 has passed across an already queried image frame and is distinct from the previously scanned location coordinates.

In certain implementations, visual detection of rip currents using a UAV controller 710 may include additional developments to existing machine-learning (ML) processes. While the traditional approach to creating ML models involves dataset collection, training, inference, implementation, and update, learning-based rip detection software uses significant modifications to each of the above components in order to efficiently detect rip currents in real-time and continuously learn for improved accuracy.

For example, the ML rip detection process may include creation of a rich accurately labeled dataset with ground truth measurements. Most datasets for ML training are built from laboriously labeled data samples by humans. Some other data collection approaches, such as pertaining to applications in the domains of science, technology, engineering, healthcare, etc. include data records hoarded for decades by companies or markets. However, data collection approaches which rely on ground truth measurements from calibrated sensors are still growing. On the other hand, labeling such data samples which consist of ground truth measurements is a laborious task. This problem is addressed by writing algorithms/heuristics to automatically label each data sample that are collected using the UAV 700 and USV 800 on the beach. Computerized analysis and classification of every raw measurement data in the generated database can be performed and each data sample can accordingly be labeled/classified as safe and moderate/dangerous rip current zones based on flow velocity measurements. Current data analysis approach incorporates measured vehicle dynamics and incident wave dynamics to extract the rip current velocity in variable external conditions. The UAV video imagery dataset, consisting of image frames and timestamps, will then be associated with the quantified ground-truth measurement dataset, via temporal correlation. Additionally, masked contoured images can be obtained from the thermal imaging camera on the UAV 700 to detect the presence of any wildlife on the shore and surf-zone so these images can be incorporated in the correlation process too. With the incorporation of the ground truth-based labeled rich dataset, the learning models can be fine-tuned to extract much finer and more subtle, yet significant, features from the visual data. This sort of correlated rip current visual dataset has not been available to accurately label rip current images and is a unique capability proposed here.

Furthermore, the ML rip detection process may include offline training of ML model for state-of-the-art rip current detection. Existing work in real-time object detection such YOLO® from Ultralytics is leveraged. These models have been trained on huge datasets that have been made open source such as COCO dataset, thus avoiding the necessity to manually collect extensive data and training a model from scratch for most applications. However, the present YOLOv11 system architecture and training methods pose limitations for rip current detection application. For example, the current system architecture supports real-time object detection by a model trained to detect more common everyday objects but does not categorize rip currents or entities pertaining to evaluation of beach safety. To solve this problem, we modify the existing architecture to incorporate categorization/classification of rip currents based on severity, estimation of number of beachgoers near a detected rip current, current swimmers counted, detection of live dangerous marine wildlife, in-situ identification of the location of swimmer emergency based on beach visitors' pose/gesture/orientation/gaze vector convergence, in-situ analysis of water samples, detection of rocks in the surf-zone. This solution requires modification to the network architecture, number and size of the hidden layer neural networks, training parameters.

Additionally, the ML rip detection process may include model refinement for lightweight edge implementation by the UAV processor 710 that may have limited processing and power capabilities. While the modification of the system architecture will focus on detection accuracy, it is equally important to focus on the edge implementation. For this reason, it is necessary to consider the computational power available on the UAV. Producing lightweight models which can be deployed on the UAV's SBC for onboard image processing and rip detection can enhance efficiency. The trained model can then be incorporated on the SBC's local software thread to concurrently read the video frames from the UAV's camera, input them to the trained model, infer the detection results from the model, and relay the result to the operator via telemetry. For power consumption reasons, this software thread can be queried only when the UAV has passed across an already queried image frame and is distinct from the previously scanned location coordinates. The specific pruning process can trim down a trained neural network, thus cutting down its size and making it implementable on the SBC and enabling quicker computations.

In certain aspects, the ML rip detection process may include low iteration rapid online learning update to pre-trained model. While most trained ML models are trained offline repetitively as new data is encountered, this presents a problem of delayed subsequent model updates and high turnaround times. To solve this problem, the UAV controller 710 identifies the most influential weights of the neural network and correlates them to the features with high variance, specific to a beach, thus enabling quicker update of weights to the neural network. This enables rapid learning of the ML model within the SBC with significant lower power consumption and having an incrementally efficient model within the span of one scanning operation of a beach segment.

In certain implementations, data collected by beach safety system 600 may be distributed by a software user interface for beach safety operational system that includes monitoring dashboard, mission planner, onsite system performance statistics, beach reports with data visualization, emergency alert notifications. The unified software user interface enables multiple applications in the beach safety and operational system and is available as computer software applications (MAC, Windows, and Linux) and smartphone applications (Android and iOS). The software can also be accessible from website URLs.

The hardware status monitoring dashboard may allow a user to monitor the status of all the hardware components in the beach safety system. For example, this interface may allow a user to access UAV-specific information such as battery status, camera(s) status, real-time trajectory tracking of the UAV, 4K live video feed and last snapshot captured, launch/transit/dock and charging status. Furthermore, a user may access life ring-specific information, such as battery status, real-time location tracking of life ring, real-time motion tracking of the life ring, signal strength of the communication system, charging status. Furthermore, a user may access life ring support stand-specific information: battery status, charging status, and communication system health, and may access live anemometric measurements, local wind direction, and light meter measurements.

A mission planner may allow a user to initiate manual launch, transit, and retrieval of the UAV 700 and to toggle between auto-pilot mode and manual control during the transit of the UAV. Additionally, the user may input autonomous operation mission parameters such as predefinition of search zone, preprogrammed scan schedule, wave breaking times, geofencing boundaries, water sample collection, operational search objectives, etc. and to manually direct the UAV to the location of the distressed swimmer and drop a floatation device with the guidance of a remote operator viewing the real-time video feed from the UAV. Furthermore, the user may download and view weather prediction forecast from NOAA for a rolling window of a certain number of hours for the operator to review before launch of the UAV and review environmental conditions from the station's environmental sensor measurements before launch of the UAV. Additionally, a user may use the mission planner to send instructions to the UAV pertaining to the autonomous missions for immediate or scheduled launch and to receive notification of a status of a launch/retrieval station, battery status, real-time video feed from UAV's camera, etc. Additionally, the mission planner allows a user to have an option to abort mission midway through transit of the UAV to return to home or nearest station, and by the end of a mission, performance statistics of the UAV and mission related information may be generated and displayed on the mission planner. Additionally, by the end of a mission, all the raw sensor-detected data and UAV's onboard processed information are automatically transmitted by the UAV to a secure web servers using the ground station communication systems. In the event of communication failure, the data can still be wirelessly downloaded onto a smartphone or laptop by connecting to the ground station communication system's local near-range communication channel.

Once the upload is complete the user is directed to the ‘report generation module’ of the unified software interface and is presented with various report generation options. For example, beach post-scan report generation may implement a report generation module to reference the recently uploaded beach scan data/information from the UAV, presents the user with various report generation options which the user can customize. Once the required options are selected, the module submits a job to cloud computing platforms via servers. The submitted job will contain the data analysis source code, raw sensor-detected data from the UAV, and the UAV's onboard processed information. The raw sensor-detected data consists of image frames from the video logged by the UAV's camera. The UAV's onboard processor information consists of the visually detected rip currents (locations, predicted intensities, and trajectories), water sample analysis result, and any detected marine wildlife, along the scanned beach segments. Cloud computing platforms are primarily used here to perform heavy computations and generate reports within a short period of time. Once the job is completed, the processed information is transmitted to the ‘report generation module’ in various forms of reports such as PDF documents or interactive maps available to the user in the software user interface.

The generated reports may contain, for example, a list of locations (e.g., GPS coordinates) with dangerous beach conditions detected by the UAV, timestamped and categorized based on the type and severity of the danger, a list of beach access points near the detected danger locations by cross-referencing the GPS coordinates of the access points within a 300-yard radius of the detected danger locations, a number of humans estimated to be at/near the dangerous locations at the time of scan based on human-detection results from the UAV's video. Additionally; image snapshots and/or video snippets of the beach dangers; and colored contours highlighted on the image snapshots/video snippets may be included in the generated reports. Furthermore, the generated reports may include contoured selection of the beach dangers in the form of a series of boundary coordinates; and interactive maps that are available for access to the user or beach communities to make any prearrangements such as restricting access to such dangerous locations on the beach and spreading awareness among the beach public. These interactive maps are generated by embedding Google Maps or other mapping software within the ‘report generation module’ in the user software interface and subsequently pointing, marking, and labeling the GPS coordinates of the dangerous beach locations on the map.

In another example, the beach safety system 600 may provide swimmer emergency alerting and tracking system statistics. For example, in addition to the beach-scan reports generated after every mission, the software interface also contains the usage and performance statistics of the Swimmer Emergency Alerting and Tracking System. Reports can be manually generated on demand or can also be periodically scheduled on the software application to send out automated reports in the form of PDF documents via emails. These reports include information on locations of ground stations, number of life ring removal events from each station, reason for the removal of the life rings, dates and times of removal/return of the life rings, etc. Furthermore, the reports may include statistics related to the performance of the communication systems such as alert durations and latencies, downtimes, data accuracy, performance of the fail-safe communication systems, etc.; and statistics related to the rescue response such as response durations, emergency personnel response times. Additionally, the reports may identify information related to the maintenance of the onsite systems and/or technical information of each onsite system such as battery charge and discharge graphs to analyze battery health, charging durations, solar panel energy efficiency and power tracking, etc.

In another example, the beach safety system 600 may provide real-time alert notifications of emergency events and dangers on the beach. For example, each ground station may act as a communication gateway for devices such as the life rings and UAVs to send messages to web servers. These messages are then relayed to IoT platforms to issue alert notifications in various forms such as SMS text messages, emails, phone calls with dynamic voice message, radio messages, smartphone push notifications, and computer application push notifications. Some or all of these forms of communication can be configured for different events such as: Removal of life-ring can trigger the generation of text messages and voice phone calls to 911 emergency dispatch services to notify first responders and rescue personnel. These automated phone calls play a dynamically generated voice message which notifies the 911 operator of the current location of the possible swimmer emergency, date and time of the event occurred, and the heading direction of the user carrying the life-ring in reference to the ground station. As previously described, removal of the life-ring 200 can also trigger a text message and email notification directly to the rescue services for a designated remote pilot-in-control to access the video feed from the ground station and/or UAV to locate the distressed swimmer and to deliver a life jacket as a first attempt of rescue response. Additionally, unauthorized access or tampering of the UAV cabinet or communication system box on the ground station will automatically trigger the generation of alert messages in all forms.

In addition to the beach conditions detected and identified by the beach safety monitoring system, the user (from the beach community) can self-report a beach condition by manually filling the fields on a form presented on the software user interface. The manually added information will be added to the list of beach conditions in the format of the technology-detected conditions.

Furthermore, the beach safety system 600 may interface with a smartphone application for public beach safety reporting system and emergency alert notifications that provides a condensed version of the software user interface smartphone application for the beach safety operational system, excluding the operational features, can be made available for the general public to download the application. This application will especially be useful to the beach public who enter unguarded beaches. The features entailed in this application will include, for example, in situ automatic notification of beach dangers and guidance to safer areas can be issued for beach visitors and the general public. As the application has access to the most recent list of dangerous conditions on the beach including their locations, a polygonal area/zone bordering the start of the shore connecting the beach access points, far end of the surf-zone out toward the ocean, either sides (with a pre-configured distance) of the prime condition location, can be marked automatically by the application. This information will be available immediately on the application when the user selects the beach of interest. With the location permission enabled by the user, the application can obtain the current live location of the user on the beach in the form of GPS coordinates. The application then automatically issues push notification alerts to the user: , for example, if the user's heading direction is towards a polygonal area bordering the dangerous condition on the beach, or if the user's current location is inside the polygonal area bordering the dangerous condition on the beach, the application may then send follow up instructions in the form of push notifications to exit the danger zone (polygonal area) towards the nearest safe areas on the beach.

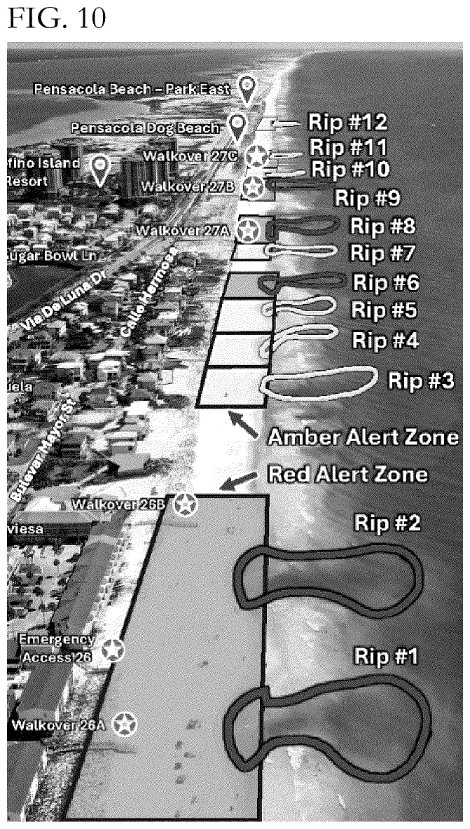

The application may also present the user with an interactive map which shows the locations of the dangerous beach conditions. For example, the interactive map may interface with another application presenting a map and modify the stored maps to identify the dangerous beach conditions. As the application may have access to a current location of the user, it runs a search of the user's location coordinates in the most recent list of beach dangers scanned and reported by the UAV or beach community. By default, the search radius will start at a distance of 300 yards. The search radius is customizable by the user in the configuration settings of the application. The application then narrows down the locations of beach events and dangers within the specified search radius and displays them on the interactive map. The polygonal areas can also be displayed on the interactive map and categorically highlighted into green (safe), amber (cautious), and red-colored (danger) alert zones as depicted in map 1000 depicted in FIG. 10. These polygonal areas can be drawn by issuing calls to a JavaScript API on the mapping software. Additionally, the contours' coordinates obtained from the ‘report generation module’ can be mapped too.

A self-reporting form for the beach public to report any previously undetected dangers on the beach. The form also allows the user to add more information to currently detected dangers on the beach, especially point-of-view (POV) photos and videos of the beach dangers, which will be updated on the database.

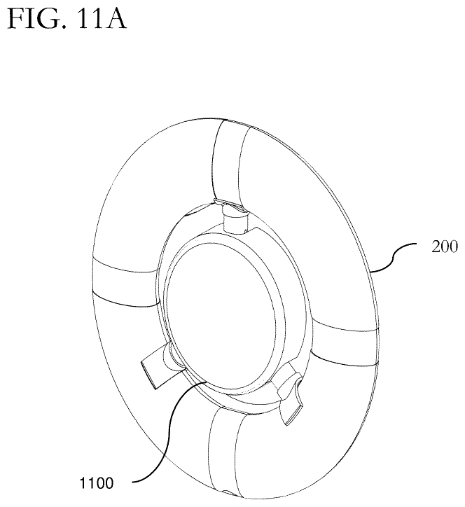

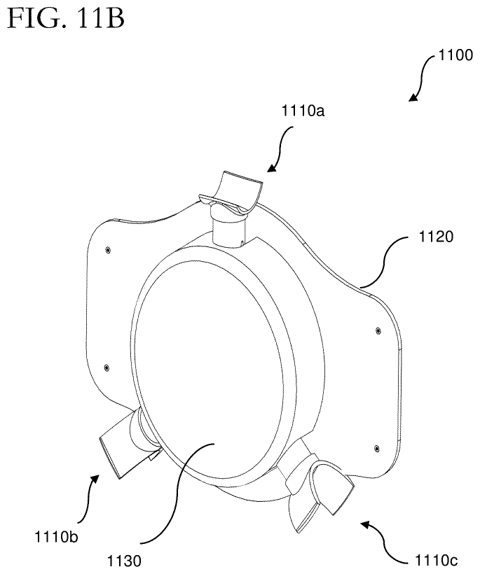

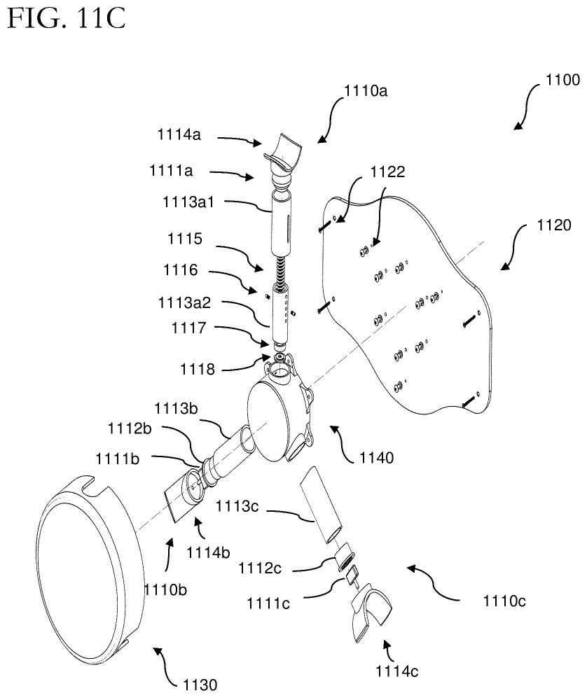

As depicted in FIGS. 11A-11C, in certain examples, the stand 300 may include a caddy 1100 provided as a tri-pole life ring holder with triple-sense detection. The caddy 1100 is a unique mechanical construct that is developed to support the removal and placement of toroid-shaped (or ring or donut) life-saving floatation devices such as life ring 200. As described below, the new mechanism of caddy 1100 eliminates false positives and false negatives pertaining to the operation of the technology by better detecting when life ring 200 is removed versus life ring 200 being improperly positioned within the caddy 1100.

The caddy 1100 may include three poles 1110a, 1110b, and 1110c to constrain any free translational movement of the life ring along the 3-dimensional axes, thus making the detection system less susceptible to wind, earthquakes, and any accidental bumps to the life-ring stand 300. The caddy 1100 may be coupled to the stand 300 by a mounting panel 1120, such as by screws 1122, and the three poles 1110a, 1110b, and 1110c may be attached to a mounting cylinder 1140 coupled to the mounting panel 1120 and which may house an IP67 waterproof enclosure within a cover 1130 with the electronics and communication components necessary to detect the presence of the life ring 200 and send out alert messages.

A first pole 1110a on the top may include a stationary inner pipe 1113a2, a compression spring 1115, an outer pipe 1113a1, a cap 1111a, and an adapter 1117 to constrain the bottom of the spring. The pole cap 1111a on the top prevents any water from going through the pipes 1113a1 and 1113a2. The spring 1115 is placed inside the inner pipe 1113a2, and the inner pipe 1113a2 is placed inside the outer pipe 1113a1. This configuration enables the compressible linear movement of the first pole 1110a. In order to prevent frictional displacements of the spring 1115, the axial movement at the bottom of spring 1115 is constrained by closing the bottom part of the inner pipe 1113a2 with a spring mounting adapter 1117. The outer pipe 1113a1 has a slotted hole on either side, whereas the inner pipe 1113a2 has an array of threaded holes which match the position of the slots on the outer pipe 1113a1. However, in order to constrain any immediate inertial release of the outer pipe 1113a1 from the compressed first pole 1110a, a half-threaded dowel stopper pin 1116 made from stainless steel may be fixed onto one hole on either side of the inner pipe 1113a2 through the slot of the outer pipe 1113a1. This mechanism prevents the outer pipe 1113a1 from experiencing any harmonic or snapping motion. A load cell 1118 is then seated on the bottom of the spring mounting adapter 1117 beneath the first pole 1110a before the first pole 1110a is connected to the mounting cylinder 1140. In certain implementations, the load cell sensor 1118 may be replaced with magnetic reed switches or photoelectric sensors as alternative sensing devices.

A second pole 1110b may include a snap-action limit switch 1111b, a switch sensor mounting adapter 1112b, and a pipe 1113b. Each of these components are connected linearly as shown in FIG. 11C. The snap-action limit switch 1111b is IP67 waterproof rated. In certain implementations, the snap-action limit switch 1111b may be replaced with a waterproof tactical push button. The switch sensor mounting adapter 1112b houses a switch and also prevents any moisture from entering the pole 1113b by serving as a cap. Second pole 1110b and third pole 1110c are symmetrical to each other in terms of design and geometry along the vertical axis, and the third pole 1110c may also include a snap-action limit switch 1111c, a switch sensor mounting adapter 1112c, and a pipe 1113c. While first pole 1110a is placed at to extend substantially upright vertically, second pole 1110b may be oriented facing the ground at an angle greater than 120 degrees from first pole 1110a. Similarly, third pole 1110c may be oriented at an angle less than 60 degrees from pole 2. The poles 1110a-1110c may be oriented in this configuration to increase the stability of the entire tri-pole structure of caddy 1100 and enable convenient release of the life ring 200 from the caddy 1100. Second and third poles 1100b and 1100c may then be connected to the mounting cylinder 1140.

All three poles 1110a-1110c are capped with a specially designed holder 1114a-1114c having an inner surface shaped to follow the inner curvature profile of an outer surface of life ring 200. The holders 1114a-1114c may be modular and generalizable to other life rings 200 also with different curvature profiles. The holders 1114b and 1114c for second and third poles 1100b and 1100c may contain a hole in the middle to enable the protrusion of a lever of the limit switches 1111b and 1111c. The 1114a-1114c holders are designed with thin walls on the front to make them flexible and support snapping release action of toroidal structures such as the life ring 200 from the caddy 1100 along the sagittal axis or perpendicular to the frontal plane of the caddy 1100, thus making these holders 1114a-1114c multi-purpose for different life rings 200 or other structures, such as a specially designed UAV 600. In certain implementations, these holders may be accompanied by motorized systems to automatically rotate or retract the holders to allow the UAV 600 to decouple and lift the life ring 200 from the caddy 1100 in the event of swimmer emergency.

The wires from the load cell 1118 of the first pole 1110a and the snap-action limit switches 1111b and 1111c in the second and third poles 1110b and 1110c may be fed through holes in the mounting cylinder 1140 which are sealed using waterproof sealant for extended waterproofness. The mounting cylinder 1140 may be attached to panel 1120 using tamperproof screws 1122. Circular front panel cover 1130 which conceals the pole mechanism and the waterproof enclosure is connected directly to the back panel using tamperproof screws 1122. The back panel 1120 which houses the entire system can then be attached to the stand 300 or other structures, such as wooden stands, walls, or even to steel clamps on PVC pipes, thus making it a multi-purpose attachment.

The outer pipes 1113a1, 1113b, and 1113c on poles 1110a-1110c can be replaced with pipes of different length to adapt the caddy 1100 to life rings 200 of different diameters. Adjustable tension on the spring-loaded top first pole 1110a accommodates the release/return motion of differently sized life-rings and the tension on the first pole 1110a can be customized as per a user's judgement.

The tri-pole system for caddy 1100 provides a robust design to accommodate sensing the presence of the life ring 200 under various conditions such as inconsistencies in the physical dimensions of life rings due to manufacturing defects, tampers, and vandalism. Communication alerts in the event of an emergency are activated when the load cell sensor 1118 and both the snap-action limit switch 1111b and 1111c are triggered at the same time due to removal of the life ring 200. In the event of tampering or vandalism, by the time the perpetrator releases the life ring and engages all three sensors 1118, 1111b, and 1111c at once, an internal alarm is sounded and communication alerts may be issued to authorized personnel. The system is also equipped with flashing probe lights for situational awareness of beach public in the event of an emergency. 360-degree rotation of the life ring 200 around its center origin is possible without triggering the alarm to enable prevention of intentional false alarms and deter vandalism.

A life ring 200 can be placed on caddy 1100 by first placing the inner or bottom surface of top portion of the life ring 200 on holder 1114a of the first pole 1110a and then pushing it down towards the ground which then automatically aligns the life ring 200 parallel to the stand due to gravitational force. The manual external force is then withdrawn by the user as the tension from the compressed spring 1115 in first pole 1110a releases and subsequently engages the life ring 200 in the bottom two holders 1114b and 1114c of the second and third poles 1110b and 1110c, thus stabilizing and securing the entire life ring 200 to the caddy 1100. Initial calibration may be used to appropriately fix the dowel stopping pins 1116 corresponding to the selected life ring 200, so there is minimum tension for the first pole 1110a to expand and brace the life ring 200.

The life ring 200 can be removed from the caddy 1100, for example, by snapping the life ring 200 out of the caddy 1100 along the sagittal axis (or perpendicular to the frontal plane of the caddy 1100) or by slightly pushing the life ring 200 down toward the ground and releasing it from the bottom two holders 1114b and 1114c which brace a lower portion of the life ring 200. These methods consume a duration of less than 1 seconds and 4 seconds, respectively, on an average, to fully remove the life ring 200 from the caddy during an emergency.

The present disclosure has been described above with reference to the accompanying drawings, but the present disclosure is not limited by the embodiments disclosed herein and the drawings, and it is apparent that various modifications may be made by those of ordinary skill in the art within the scope of the technical idea of the present disclosure. Further, even when the effects according to configurations of the present disclosure are not explicitly described while describing the embodiments of the present disclosure, predictable effects of the corresponding configurations should also be recognized.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed:

1. A system comprising:
a stand including:
a coupling region; and
a charger;
a life preserver including:
a body configured to be removably mounted to the coupling region of the stand and to provide buoyancy to a swimmer;
a life preserver battery provided in the body and that receives power from the charger when the body is positioned at the coupling region;
at least one electronic component provided in the body and that receives power from the battery when the life preserver is removed from the coupling region.

2. The system of claim 1, wherein the charger of the stand includes a solar panel that converts sunlight into power.

3. The system of claim 2, wherein the charger of the stand includes a stand battery that stores at least a portion of the power generated by the solar panel, and that provides power to the battery of the life ring.

4. The system of claim 1, wherein the stand includes:
a first sensor to detect when the life preserver is removed from the coupling region; and
a stand communication interface that transmits an indication to another device that the life preserver is removed from the coupling region.

5. The system of claim 4, wherein the first sensor detects a magnetic field associated with at least one of a metal object or a magnet included in the life preserver.

6. The system of claim 4, wherein the stand includes:
a second sensor to capture an image of user removing the life preserver when the life preserver is removed from the coupling region.

7. The system of claim 6, wherein the stand communication interface transmits the image to the other device.

8. The system of claim 4, wherein the life preserver includes a radio-frequency identification (RFID) tag associated with an identifier for the life preserver, and
wherein the first sensor includes an RFID receiver to acquire the identifier from the RFID tag when the life preserver is mounted to the coupling region.

9. The system of claim 1, wherein the body has an annular shape.

10. The system of claim 1, wherein coupling region includes at least three poles that extend in radial directions to contact the body, and one of the poles includes a spring that provides a force against the inner annular surface of the body.

11. The system of claim 10, further comprising at least one of:
a first sensor provided at the one of the poles to detect whether the spring is compressed; or
a second sensor provided at another one of the poles to detect when the other one of the poles is in contact with the body.

12. The system of claim 1, wherein at least one electronic component of the life preserver includes at least one of:
a location senser to identify at least one of a location or a movement of the life preserver; or
an environmental senser that detects one or more of when the life preserver is positioned in water, a direction a wave at the location of the life preserver, or a magnitude of the wave at the location of the life preserver.

13. The system of claim 12, wherein at least one electronic component of the life preserver includes a communication interface to transmit information collected by the at least one of the location sensor or the environmental sensor.

14. The system of claim 1, wherein at least one electronic component of the life preserver includes an output device that provides at least one of an audio or a visual indication when the life preserver removed from the stand and positioned in water.

15. The system of claim 1, wherein at least one electronic component of the life preserver includes a dispensing device that releases a fluorescent material to provide a visual indication of a current in the water.

16. The system of claim 1, wherein the life preserver includes a switch that activates a supply of power from the battery to the at least one electronic component when the life preserver is removed from the stand.

17. The system of claim 1, further comprising:
an unmanned aerial vehicle (UAV) that includes
a UAV motor to move the UAV through air;
a UAV sensor to capture images;
a UAV controller to manage the motor such that the UAV moves from the stand and along a prescribed path and to process images captured by the UAV sensor to identify a dangerous water and shore conditions; and
a UAV battery to provide power to the UAV motor, UAV sensor, and UAV controller and that receives power from the charger when the UAV is positioned at the stand.

18. A system comprising:
a stand including a charger;
an unmanned aerial vehicle (UAV); and
an unmanned surface vehicle (USV),
wherein the UAV includes:
a UAV motor to move the UAV through air;
a UAV sensor to capture images;
a UAV controller to manage the motor such that the UAV moves from the stand and along a prescribed path and to process images captured by the UAV sensor to identify a dangerous water and shore conditions; and
a UAV battery to provide power to the UAV motor, UAV sensor, and UAV controller and that receives power from the charger when the UAV is positioned at the stand; and
wherein the USV includes:
a USV motor to move the USV through water;
a USV sensor to detect information regarding one or more water conditions while the USV moves through water; and
a USV controller that processes the information regarding the one or more water conditions to identify the dangerous water and shore condition, and
wherein the UAV controller receives information regarding detection of the dangerous water and short condition by the USV and uses this information to train a machine learning process to process the images captured by the UAV sensor.

19. The system of claim 18, wherein the UAV travels along a first path that is parallel to a shore, and the USV travels along a second path that includes a first preset portion while the USV is moving through water to detect the dangerous water condition, and a second portion in which the USV deviates from first preset portion after the dangerous water and shore condition is detected to perform one or more additional passes through the dangerous water and short condition at different distances from the shore.

20. The system of claim 18, further comprising a computing device that receives information regarding the dangerous water and shore condition from at least one of the UAV or the USV and generates a map identifying a location of the dangerous water and shore condition and to provide a smartphone application that has isitu beach conditions reporting that provides an application that generates and presents a map identifying real-time locations of rip currents and other water conditions within a preset distance of a user device.
